(19) United States
(12) Patent Application Publication
(10) Pub. No.: US 2018/0155059 A1
(43) Pub. Date: Jun. 7, 2018

(54) A SYSTEM FOR HANDLING OF LUGGAGE OR PARCEL ITEMS

(71) Applicant: BBHS A/S, Hedehusene (DK)

(72) Inventors: Lars THOGERSEN, Copenhagen S (DK); Ulrik SVENNINGSEN, Valby (DK); Krisztian GRIZ, Taastrup (DK)

(21) Appl. No.: 15/571,706

(22) PCT Filed: May 6, 2016
(86) PCT No.: PCT/EP2016/060201

§ 371 Date: Nov. 3, 2017

(30) Foreign Application Priority Data
May 6, 2015 (EP) 15166632.8

(51) Int. Cl. B64F 1/36; B65G 1/137

(52) U.S. Cl. CPC B64F 1/368; B65G 2201/0264; B65G 2201/0285; B65G 1/1375

(57) ABSTRACT

A system for handling of luggage or parcel items comprises a principal conveyor for conveying the items to respective unloading positions along the principal conveyor, and a first item buffer section comprising a number of first item accumulation units arranged at the unloading positions of the principal conveyor. Each of the first item accumulation units comprises a plurality of shelves for storing a plurality of items on each shelf. At least one directing apparatus at each unloading position is provided for directing the items onto the shelves of the first item accumulation units. A second item buffer section comprises second item accumulation units comprising a plurality of shelves for storing a plurality of items on each shelf. An item transfer apparatus is arranged to receive items unloaded from the first item accumulation units. A control system controls operation of the item transfer apparatus.

### TECHNICAL FIELD

The present invention relates to a system for handling of luggage or parcel items, for example at airports or parcel sorting and distribution facilities. One aspect of the invention is particularly concerned with an item handling and distribution facility for items offloaded from a principal conveyor, such as a sorting conveyor. Another aspect of the invention is particularly concerned with an interface between a cart for transport of items and a sorter or conveyor site.

### BACKGROUND OF THE INVENTION

Various systems are known for transporting, sorting and storing various items and goods, including luggage and parcel items. Such systems are usually tailored to meet specific requirements set by the nature, size and weight of the items, as well as requirements regarding sorting, transport distances and speed of transportation.

One specific field of interest of the present application is the field of transportation and storage of luggage or parcel items in airports. In most airports, checked-in luggage is usually conveyed from a plurality of check-in counters to a central luggage conveying and/or sorting apparatus, referred to herein also as a principal conveyor, at which each luggage item is sorted according to its destination. Such conveying and/or sorting apparatus normally comprises a plurality of discharge units, in each of which luggage items destined for a particular aircraft are accumulated. The luggage items are then manually loaded onto carts or trolleys, by means of which the items are transported to the aircraft. The carts or trolleys may be self-propelled, or they may be attachable to a propelling unit (or tractor), which may be arranged to pull a plurality of trolleys or carts coupled together to form a train. Likewise parcels being sorted are typically discharged from a sorting conveyor into a plurality of collecting stations, each of which is designated for a particular destination. From the collecting stations, the parcels are transported in trollies, carts, containers, cages or bins to an aircraft.

Arriving luggage and arriving parcels at airports are typically conveyed from an aircraft site in similar trollies, carts, containers, cages or bins to a conveyor, which conveys the items onto a sorting conveyor, if the items are in transit, or to a luggage reclaim belt or a parcel distribution facility if the items have arrived at their final destination airport.

International patent publication No. WO 2008/020084 discloses a cart for transport and storage of items comprising a plurality of inclined shelves arranged in rows and columns. The cart can be coupled to an identical cart, and multiple coupled carts may thus form a train. Though the cart disclosed in WO 2008/020084 greatly improves luggage handling between airplane sites and airport conveyors, a need for further facilitating of luggage and parcel handling at airports, sorting facilities and similar locations has arisen.

Moreover, some airports, airport operators and airlines may for various reasons have decided not to implement the cart of WO 2008/020084, and under such circumstances an even greater need exists for expediting handling of luggage and parcels.

### SUMMARY OF THE INVENTION

On the above background it is an object of embodiments of the invention to provide a system, which expedites handling of luggage and parcels at airports, sorting facilities and similar facilities, notably in the sense of providing a system which reduces the need for manual labour work. It is a further object of embodiments of the invention to provide a system which improves operator convenience in relation to, e.g., early luggage, reduces the time during which the items are underway between a sorter or conveyor and an aircraft site or vice versa. It is a still further object of embodiments of the invention to provide a system, installation and operation of which is easy, and which can be integrated with a variety of different sorting system. It is a still further object of embodiments of the invention to provide a system, which enhances capacity utilization per square meter of the conveyor and sorting systems, as well as of the building premises housing such conveyor and sorting systems. It is a still further object of embodiments of the invention to provide a system, which enhances sorter output capacity and enables segmentation of items, such as pieces of luggage or parcels, notably with a view to enabling individual handling of different groups of items. It is a further object of embodiments of the invention to provide a system for loading departing luggage or parcels onto suitable carts sufficiently fast for the loading process to take place outside a sorting facility building.

In a first aspect, the invention hence provides a system for handling of luggage or parcel items, comprising:
at least one principal conveyor for conveying the items to respective unloading positions along the principal conveyor;
a first item buffer section comprising a number of first item accumulation units arranged at the unloading positions of the principal conveyor, wherein
   each of the first item accumulation units comprises a plurality of shelves for storing a plurality of items on each shelf, each shelf extending in a longitudinal direction from an inlet end of the first item accumulation unit to an outlet end thereof; and wherein
at least one directing apparatus at each unloading position for directing the items onto the shelves of the first item accumulation units;
a second item buffer section comprising a number of second item accumulation units, wherein each of the second item accumulation units comprises a plurality of shelves for storing a plurality of items on each shelf, each shelf extending in the longitudinal direction from an inlet end of the second item accumulation unit to an outlet end thereof;
an item transfer apparatus for receiving items unloaded from the first item accumulation units at their unloading ends, and for loading the items unloaded from the first item accumulation units onto the second item accumulation units at their loading ends;
a control system for controlling operation of the item transfer apparatus, so as to distribute the items unloaded from the first item accumulation units among the second item accumulation units.

The item accumulation units provide a dual functionality. Firstly, they provide a buffer between the principal conveyor and a transport means, such as a cart for taking the items to e.g. an aircraft site. Secondly, the plurality of successively arranged item accumulation units and the item transfer apparatus between rows of first and second item accumulation units allow the item accumulation units and the item transfer apparatus to be used as a sorter. Accordingly, the capacity of the system may be increased as compared to traditional sorting conveyors (an example of such a traditional sorting conveyor being referred to herein as the principal conveyor), in which separate discharge stations at unloading positions, typically in the form of chutes, are provided for each destination. In such traditional systems, a chute is typically assigned to accommodate luggage for a particular departure during a time interval from about 2-3 hours prior to departure until shortly before departure. Hence, during that time interval the unloading position (e.g. chute) is occupied and cannot be used for luggage for another aircraft, and the sorting conveyor accordingly has to be sufficiently long to accommodate a number of discharge stations proportionate to the airport or other item sorting facility, at which the conveyor is installed. In contrast, in the first aspect of the present invention, the item accumulation units can be used as buffers for luggage or parcels, whereby items for a plurality of destinations may be offloaded from the principal conveyor at one single unloading position. Hence, the length of the principal conveyor and the number of discharge chutes may be reduced without compromising the overall capacity of the system, and/or the overall capacity of the system may be increased without increasing the number of unloading positions or making other modifications to the principal conveyor.

It should be understood that the longitudinal direction is preferably aligned with horizontal. Preferably, the longitudinal direction is parallel to horizontal or only slightly inclined relative to horizontal, such as inclined by at most 20°, preferably at most 10°, such as at most 5° or less, such as at most 3°.

The items transfer apparatus and the item accumulation units further allow luggage or parcels to be sub-segmented, i.e. sorted into groups of items, according to their destination and/or priority status. For example, items in transfer may be collected a specific one of the second or further (i.e. downstream) item accumulation units. Items for local destinations may be collected in another one of the second item accumulation units, items having short connections may be collected at yet another one of the second item accumulation units, and items for destinations requiring special security measures to be taken, such as VIP or staff presence or other airline specific sub-segmentation, may be collected at a yet further one of the second item accumulation units.

Preferably, the item transfer apparatus is transversable movable in a space between successive buffer sections. Herein, transversably should be understood to mean be a direction transverse to the conveying direction for the items through the item accumulation units and the item transfer apparatus, i.e. a direction transverse to the conveying direction from the unloading positions at the principal conveyor towards dispatch units at a downstream end of the system.

In order to enhance operational speed and throughput of the system, the shelves of the first and second item accumulation units may be aligned, so that the shelves are preferably parallel, extending in the longitudinal direction. Each of the shelves of the item accumulation units may be provided with a conveyor belt or other conveying means for moving the items from the respective inlet ends of the accumulation units towards their respective outlet ends. In one embodiment, the shelves may be slightly inclined relative to horizontal, so that items may automatically slide under the action of gravity from the inlet end to the outlet end of the item accumulation unit.

Capacity of the system is increased by each shelve being preferably sized to store a plurality of the items at a time. In preferred embodiments of the invention, each shelve is preferably sized to store the plurality of items successively, i.e. one behind the other in the longitudinal direction. Thus, buffer capacity may simultaneously be increased.

In order to facilitate the system and render it inexpensive, the item accumulation units are preferably immobilized. Thus, conveying of items in the accumulation units may preferably take place only horizontally or nearly horizontally in the longitudinal direction, whereas horizontal transverse movement or movement, which is essentially vertical, is prevented in the item accumulation units.

Preferably, the directing apparatus and the item transfer apparatus are arranged to be transversely movable relative to the longitudinal direction. The directing apparatus and/or the item transfer apparatus may thus be controlled to distribute the items among the plurality of buffer sections. The directing apparatus and/or the item transfer apparatus may be further arranged to elevate items to a position for delivery onto a selected shelve of the item accumulation units. Thus, in embodiments, in which the shelves of each accumulation unit are stacked on top of each other, the directing apparatus and/or the item transfer apparatus may be configured and controllable to feed items into a selected shelve of a selected item accumulation unit. Each of the directing apparatus and/or the item transfer apparatus may comprise a conveyor for moving the items in the longitudinal direction, i.e. in a direction which is aligned with and preferably parallel to the direction, in which items are conveyed within the item accumulation units.

It will thus be appreciated that vertical movement of items is carried out only within the directing apparatus and/or within the item transfer apparatus. Thus, the need for costly and relatively slowly operable elevator structures may be restricted to the directing apparatus and/or the item transfer apparatus. In particular, the need for overhead elevator or crane arrangements may be obviated. In order to further facilitate the system, only one of the directing apparatus and/or item transfer apparatus may be configured to move items vertically. In embodiments comprising a plurality of items transfer apparatus only one of the plurality of item transfer apparatus may be configured to move items vertically.

Capacity and processing speed may be further enhanced in embodiments, in which the directing apparatus and the item transfer apparatus serve themselves as buffer units for items. Thus, each of the directing apparatus and/or the item transfer apparatus may comprise at least one shelf extending in the longitudinal direction for storing a plurality of items, preferably for successive storage thereof, one behind the other in the longitudinal direction.

In order to further increase capacity of the system, the item transfer apparatus may be controllable to combine items from at least two of the unloading positions at the principal conveyor into a single dispatch station or into any one of the dispatch stations. In this manner, the item accumulation units and the item transfer apparatus may be controllable to individually sort the items or batches of items to particular dispatch stations. In one embodiment, this functionality may be configured in a manner that allows temporary storage positions, shelves or entire item accumulation units to be arranged downstream as well as (temporarily) upstream of any one of the item accumulation units. The control system of the item accumulation units and the item transfer apparatus may be independent from the control system of the principal conveyor, or it may be integrated therewith. For example, the principal conveyor may embody sorting functionality, which may be integrated with sorting functionality of the item accumulation units and the item transfer apparatus to form batches of items for particular destinations. Alternatively, the principal conveyor may sort items according to a first set of sorting criteria, whereas detailed sorting may be carried out at the item accumulation units and the item transfer apparatus.

The shelves of each accumulation unit may conveniently be arranged as a matrix configuration including a plurality of rows and columns of shelves in each unit. For example, each accumulation unit may include 6 or 9 nine shelves arranged in a 3×2 or 3×3 matrix configuration.

The system may comprise any number item accumulation units. In preferred embodiments, the item accumulation units are arranged in rows, whereby the item transfer apparatus is/are provided between successive rows of the item accumulation units when seen in the conveying direction of the items. Each item transfer apparatus may be transversably movable in a space between successive item accumulation units, notably between successive rows of item accumulation units. One single item transfer apparatus may be provided between two successive rows of item accumulation units, or alternatively more than one item transfer apparatus may be provided between successive rows. On the one hand, the provision of a single item transfer apparatus between two rows increases flexibility of the system in the sense that items may be transferred from any item accumulation unit of an upstream row to any item accumulation unit of a successive downstream row. On the other hand, the provision of a plurality of item transfer apparatus between two successive rows may increase throughput and hence operating speed of the system. In the case of a plurality of item transfer apparatus between two successive rows of item accumulation units, means may be provided transferring items between item transfer apparatus. This configurability of the system enhances its ability to accommodate differences in the handling of luggage for route network carriers that have a number of sub-segmentations, whether as low cost carriers and charter traffic only having point to point and therefor no segmentation needs, but generally shorter turn around times asking for high speed.

Generally, a plurality of dispatch stations may be provided downstream of the outlet of at least one of the item accumulation units, wherein the or each item transfer apparatus is controlled to sort, buffer or accumulate the items, so as to direct each item to an individually selected one of the dispatch stations, or to a group of selected dispatch stations. When transferred to the dispatch stations, a full dispatch station containment will be equal to the containment of a cart, to which the items will subsequently be transferred. Preferably, a furthest downstream row of the item accumulation units forms a row of such dispatch stations. Generally luggage may be gradually consolidated in an upstream movement (for example temporarily for storage, e.g. upstream of the system) on shelves going to columns that will then be consolidated in 2 or 3 columns adequate to the chosen cart (2 or 3 columns) configuration when moved to the dispatch unit.

Thanks to the match of the carts' configuration of shelves and the configuration of shelves of the accumulation units and/or the dispatch stations, i.e. thanks to alignment of the shelves of the accumulation units and/or the shelves of the dispatch stations with the shelves of the carts, items may be conveyed from accumulation units or dispatch stations by movement in the longitudinal direction only, i.e. without the need for vertical or rotary movement. Accordingly, capacity and throughput may be enhanced, and yet costs of the system may be kept at a minimum.

In general, the number of item accumulation units in one row may be different from the number of item accumulation units in another row. For example, the number of item accumulation units in an upstream row may be higher than the number of item accumulation units in a downstream row. In one embodiment the number of item accumulation units in each row is lower the number of units in any upstream row. Hence, the item accumulation units form a funnel or rump configuration for merging items from a plurality of inputs to fewer dispatch units. In a rump configuration, a middle zone thereof will be wider than upstream and downstream zone, so as to leverage daily peaks.

In order to increase flexibility and capacity of the system, at least one of the plurality of item transfer apparatus may be operable to selectively convey the items forwardly in a direction towards the dispatch stations or backwardly in a direction away from the dispatch stations, e.g. into temporary storage positions. Hence, if a row of item accumulation units is occupied and yet in need of further buffering space, any upstream or down item accumulation unit can be used as a buffer.

While the item transfer apparatus may itself/themselves form a buffer for the items being transferred between successive rows of item accumulation units, embodiments of the first aspect of the invention may in addition to the item transfer apparatus comprise one or more separate item buffer units in the space between successive ones of the item accumulation units. Accordingly, the storage and buffering capacity of the system may be increased. The item buffer unit may be stationary, or it may be transversely displaceable in the space between successive row of item accumulation units. Hence, the buffer unit may itself contribute to sorting of items by appropriate control thereof.

Each of the item accumulation unit and each of the item buffer units may comprise a plurality of shelves, whereby each shelf may preferably be configured and sized to accommodate a plurality of items. In order to benefit from the height typically available at luggage and parcel processing facilities, such as at airport or mail distribution sorting premises, the plurality of shelves of the item accumulation units and/or buffer may be arranged in stacked rows, i.e. one above the other. Moreover, the item accumulation units and/or the item buffer units may comprise a plurality of columns of shelves. The plurality of shelves may furthermore be arranged in a lifting or elevating structure or frame that allows the unit shelves to deliver or collect luggage or parcels at one or more rows at a level above the main downstream flow of the system for temporary storage or for sorting reasons.

In order to promote conveying of the items through the system, the shelves of the item accumulation units and/or the shelves of the item buffer units may be configured to convey the items stored on each shelf from a loading end to an unloading end of the shelf. For example, the shelves may be formed as conveyor belts. Alternatively or additionally the shelves may be inclined relative to horizontal and provide a low frictional surface, such as a plurality of roller elements, for achieving the desired movement of the items under the action of gravity.

The at least one directing apparatus for transferring items from the unloading positions at the principal conveyor to a first one of the item accumulation units (or the first row of item accumulation units) may comprise an elevateable conveyor operable to selectively feed each of the items unloaded from the principal conveyor onto a selected shelf of the first item accumulation unit. The elevatable conveyor may e.g. include a pivotable conveyor hinged at one end, whereby the height position of the other end is adjustable, or alternatively the elevatable conveyor may comprise a vertically displaceable conveyor belt section.

Embodiments of the system of the first aspect of the present invention are easily adaptable to any item processing facility under construction or any existing facility thanks to its modularity. In particular, the system, except for the principal conveyor, may be modularly assembled from a plurality of building block elements, the building block elements comprising the item accumulation units, the item transfer apparatus, and the buffer units. At the design phase of any embodiment of the system, the number of rows of accumulation units, the number of units in each row, the number of item transfer apparatus, the number of buffer sections may be selected to match the needs as required by the particular application, capacity requirements, spatial constraints, etc.

Moreover, each of the item accumulation units, the item transfer apparatus, and the optional item buffering units may be modularly built from a plurality of identical standard components, such as frames, racks, drives, roller elements, conveyor segments, base elements etc., in order to reduce manufacturing costs and ease assembly.

At the principal conveyor, an “out of gauge” item unloading position may be provided for receiving “out of gauge” items, which do not fit into the modules of the remaining parts of the first aspect of the present invention, notably the item accumulation units, the optional buffer sections, and the item transfer apparatus.

Further, in order to prevent inappropriately sized or oriented items from entering the item accumulation units, the optional buffer sections, and the item transfer apparatus, the system may comprise compliance determination means for determining each item's geometrical compliance and/or its orientation compliance with the item accumulation units. Deflection means for deflecting non-compliant items away from the first item accumulation units may be provided, so as to prevent the non-compliant items from being loaded into the item accumulation units, the deflection means being preferably arranged between the unloading position at the principal conveyor and the first item accumulation unit. The deflection means may for example comprise a computer-controlled pusher mechanism, such as a swiping arm, for deflecting non-compliant items into a side branch chute.

The item accumulation units at the dispatch stations may form a row of dispatch units, at which one of a plurality of wheeled carts may be parked for removal of batches of items for further processing thereof, such as loading onto an aircraft. In one embodiment, each cart may comprise a chassis and a storage section comprising a plurality of cart shelves for accepting items unloaded from the dispatch units, wherein the storage section of each cart is rotatable relative to the cart's chassis around an upright axis. Thus, the carts may be driven to the dispatch units in a longitudinal orientation, forming e.g. a train of carts driven by a tractor or other towing device, and once parked the storage sections of the carts may be rotated by approximately 90° or by any other appropriate angle, such as by an angle of between 45-90° if dispatch units not are perpendicular to a “load road” position for receiving the items. Preferably, each cart comprises a number of inclined shelves, the number and configuration of shelves matching the number and configuration of the shelves of the dispatch units.

In embodiments of the invention, the control system may be configured to transfer control data from a control system of the principal conveyor in order to keep track of the items throughout the system. In particular, item identification information may be transferred and/or processed to enable tracking of items to the carts, and optionally further to designated aircrafts in an airport implementation of the invention. The directing apparatus, the item buffer sections, the item transfer apparatus, the dispatch stations and/or the carts may thus comprise adequate control functionality as part of the system's control system to allow tracking of items.

In a second aspect, the invention provides a system for handling of luggage or parcel items, comprising:

at least one cart comprising a plurality of cart shelves, each of which is sized to accommodate a plurality of said items;
at least one item conveyor selected among:

a sorting conveyor for conveying the items from a sorting conveyor loading position to respective unloading positions along the sorting conveyor; and

a delivery conveyor for conveying the items from a delivery conveyor loading position to a luggage reclaim area, or to the sorting conveyor, or to a parcel distribution facility, or to a further conveyor;

characterised by:
at least one item accumulation unit arranged in proximity to at least one of:
said unloading positions of the sorting conveyor and
the delivery conveyor loading position,
said item accumulation unit being configured to store a plurality of the items on a plurality of accumulation shelves;

an item transfer structure configured to transfer said plurality of the items from the sorting conveyor or from the shelves of the at least one cart into the item accumulation unit;

an electronic control system for controlling operation of at least one of the item accumulation unit and the item transfer structure.

It will hence be appreciated that the accumulation unit provides a means—or a buffer—forming an interface between the cart and the items conveyor. For departing items, such as departing luggage or parcels at an airport or parcel distribution facility, the item conveyor usually comprises the sorting conveyor, whereas for arriving items, such as arriving luggage at an airport or arriving parcels, the item conveyor comprises the delivery conveyor. In one embodiment of the accumulation unit, it intermittently stores, i.e. buffers, a plurality of departing items, and in another embodiment it buffers a plurality of arriving items. Accumulation units according to both embodiments may be included in the system according to the second aspect of the invention. Departing items unloaded from the sorting conveyor are allowed to be accumulated by the accumulation unit before they are transported away to, e.g., an aircraft site by the cart. Arriving items unloaded from the cart are allowed to be accumulated by the accumulation unit before they are loaded onto the delivery conveyor. The accumulation unit hence provides an item buffer between the sorting conveyor and the cart, and/or between the cart and the delivery conveyor, respectively. By the provision of the accumulation unit at the delivery conveyor loading position, carts may be swiftly emptied, even when there is no available space at the delivery conveyor for the items, whereby the emptied carts can be made available for other purposes without delay. Similarly, by provision of the accumulation unit at the unloading positions of the sorting conveyor, items may conveniently be collected and optionally aligned at the accumulation unit, in which case the accumulation unit may preferably be configured to load the items directly onto the cart whenever the cart is parked at the accumulation unit in a state ready to accept items.

It will be understood the features of the first and second aspects of the invention may be combined in common embodiments. In particular, the first and second item accumulation units of embodiments of the first aspect of the invention may be configured identically with—and/or embodied as—the item accumulation units of embodiments of the second aspect of the invention, comprising a plurality of accumulation shelves as discussed further below.

The system of the second aspect invention may comprise a single departure accumulation unit or a plurality of departure accumulation units, such as at least five or at least ten or at least 20 departure accumulation units. A single arrival accumulation unit or a plurality thereof may be provided. In one embodiment of the second aspect of the invention, the system comprises more departure accumulation units than arrival accumulation units.

In the second aspect of the present invention, transfer of items to and from the cart shelves, and to and from the accumulation shelves of the accumulation units may occur in an automated manner without manual labour intervention. The item transfer structure may include transfer means at any one of the at least one cart, the accumulation unit(s), and the item conveyor. As regards the at least one cart, the item transfer structure may include an inclination of the shelves so as to cause items to slide from a loading end of the cart towards an unloading end thereof under the action of gravity. Alternatively, or additionally, belts or other item transferring means may be provided on-board each cart for moving items along each shelf of the cart. As regards the accumulation units, the item transfer structure may include inclined sliding surfaces for causing items to move under the action of gravity from a loading end of the accumulation unit, and/or belt structures and/or other item transferring means. At the item conveyor, pushers, belts, tiltable trays, or any other suitable means may be provided to constitute the item transfer structure or part thereof.

In embodiments of the second aspect of the invention, in which the cart comprises a plurality of shelves arranged in rows and columns, the accumulation unit and its accumulation shelves may be configured with an equal number of rows and columns arranged at approximately identical distances as the distances between the shelves of the cart, so that each shelf of the accumulation unit may be mated with a shelf of the cart, be it for arriving or departing luggage. Thus, generally the accumulation shelves of the item accumulation unit may be configured to form a structure of first columns and/or rows, and the cart shelves of the at least one cart may be configured to form a second structure of columns and/or rows, whereby each respective accumulation and cart shelf of one of the first and second structures essentially lies flush with the other one of the first and second structures when the at least one cart is in a predetermined parking position relative to the item accumulation unit.

For luggage applications, the sorting conveyor loading position may be provided at or connected to a luggage check-in area of an airport.

For departing items, the item conveyor comprises the sorting conveyor, in which cases the item accumulation unit preferably comprises at least one column of the plurality of accumulation shelves, which are hence arranged one above the other. A plurality of columns may be provided next to each other, so that the accumulation unit forms a matrix structure of shelves arranged in rows and columns. In such embodiments, the item transfer structure may preferably be configured to selectively discharge each one of the pluralities of items from the sorting conveyor into a selected one of said accumulation shelves. The sorting conveyor and the item transfer structure may thus for example be configured to load priority items, such as priority luggage items, into a particular one of the shelves, and other items into another one. Items may be further categorized by the control system. For example, respective designated shelves may be provided in the accumulation unit for the following categories of items:

Non-priority items, which arrive at their final destination with the departing flight.

Priority items, which arrive at their final destination with the departing flight.

Non-priority items, which will be in transit at their next flight's destination airport.

Priority items, which will be in transit at their next flight's destination airport.

Short-connection items, which are to be rushed at the present airport or the destination airport.

Further categories of items may be envisaged and implemented in embodiments of the control system of the present invention.

In general, the control system may be configured to assign, to each of the items, a particular accumulation shelf of the departure accumulation unit, before the items is being loaded into the departure accumulation unit from the sorting conveyor. Thus, the designated departure accumulation unit for each item may be predetermined—or defined by—the control system of the system, thus maximizing the utility of the available space at the departure accumulating unit(s) and balancing the desire for categorization and priority assigning to individual items to available space constraints.

Alternatively, the items may be loaded onto a plurality of shelves of the accumulation unit in a way that merely packs one shelf at a time with no categorization or priority scheme being applied.

For controlled offloading from the sorting conveyor onto the accumulation shelf or shelves of the accumulation unit, the item transfer structure may comprise a pusher for individually pushing each one of the items from the sorting conveyor into the item accumulation unit in a direction transverse to a direction of movement of the sorting conveyor. The operation of the pusher may be electronically controlled by an operating system of the sorting conveyor. The control system of the sorting conveyor may further be configured to select one of the accumulation shelves for each item and to control the item transfer structure to the selected accumulation shelf. Thus, each individual item may be reliably and gently transferred to the designated shelf.

The sorting conveyor, the pusher, the accumulation unit and/or a supporting structure of any one of the aforementioned elements may comprise height-displacement means operable by the control system for ensuring that the items are discharged into the selected designated shelf of the accumulation unit.

The item accumulation unit may itself comprise an item movement structure for automatically moving each one of the items accommodated by each one of the accumulation shelves from a loading end thereof towards an unloading end thereof. For example each shelf of the cart may be inclined with respect to horizontal, the shelf thereby defining an upper end and a lower end, the upper end of the shelf being arranged at a loading end of the cart, and the lower end being arranged at an unloading end of the cart. A releasable closure structure may be provided at the lower end of the shelf, the closure structure having a closing position, in which it retains items supported by the shelf in the cart, and an open, non-closing position, in which items may be removed from the cart at the lower end of the shelf. In one embodiment, the cart may be as claimed and disclosed in international patent publication No. WO 2008/020084, which is hereby incorporated by reference.

For processing of arriving items in transit, the delivery conveyor may connect to the sorting conveyor for transfer of the items from the delivery conveyor loading position onto the sorting conveyor, and for processing of arriving items, which are at their final destination, the delivery conveyor may connect to a luggage reclaim belt for transfer of the items from the delivery conveyor loading position onto the luggage reclaim belt. The loading position of the delivery conveyor may be the same in both instances, with the delivery conveyor branching into a connector conveyor for the sorting conveyor and a further connector conveyor for the luggage reclaim conveyor.

In order for the system to efficiently process both departing and arriving items, the at least one accumulation unit may comprise respective departure and arrival accumulation units. The departure and arrival accumulation units may be identical, or they may preferably be configured differently.

For departing items in particular, the at least one cart may be sized and configured to accommodate a number of items comparable to the number of items accommodate able by the accumulation unit. It may hence be ensured that one cart or a predetermined number of a plurality of carts may in fact accommodate all of the items of the accumulation unit. Generally, the at least one cart may be sized and configured to accommodate a first number of the items, and the accumulation unit for departing items may be sized and configured to accommodate a second number of items, whereby the first and second numbers differ by at most 1000%, such as at most 10-800%, such as at most 20-500%, such as by at most 100%. In preferred embodiments of the second aspect of the invention, the number of shelves of the accumulation unit is identical to the number of shelves of the cart. Hence, as regards the departure accumulation unit in particular, the length of each shelf of the accumulation unit preferably differs relative to the length of each cart shelf by at most 1000%, such at most 10-800%, such as at most 20-500%, such as by at most 100%. In one embodiment of the departure accumulation unit, the length of each shelf of the accumulation unit is substantially equal to the length of each shelf of the cart, or differs therefrom by at most 20%, whereby the departure accumulation unit may accommodate the same number of items as the cart.

When loading the exact same number of items from the departure accumulation unit onto the cart, a list of item identifies may at the same time be passed by a central server or an accumulation unit controller of the control system onto a portable device carried by an operator at the aircraft site or kept at the drivers seat in the tractor. The operator at the aircraft site may hence verify the destination, origin, ownership or other data associated with each item immediately prior to loading thereof into the aircraft.

As far as arriving items is concerned, the accumulation unit may preferably be configured to accommodate a number of items, which is significantly greater than the number of items accommodated by each cart. Generally, the at least one cart may be sized and configured to accommodate a first number of the items, and the accumulation unit for arriving items may be sized and configured accommodate a second number of items, which is at least equal to two times the first number. The accumulation unit may thus efficiently serve as a buffer for arriving items. Alternatively, two single length accumulation units may be employed to empty two carts simultaneously.

With a view to facilitating movement of items into and out of the accumulation unit, each of the shelves of the item accumulation unit may comprise an accumulation conveyor belt. The items may thus be moved through the accumulation unit under the action of the accumulation conveyor belt. Operation of the accumulation conveyor belt is preferably controllable by the electronic control system, and may be synchronized with the operation of an item movement structure of the cart.

In respect of arriving items, the accumulation shelves of the item accumulation unit may be arranged in rows one above the other, whereby the accumulation unit may be configured to feed the items from a lower one of the rows directly onto the delivery conveyor. The accumulation unit may further comprise a discharge chute at an unloading end of upper ones of the shelves for dropping the items onto the delivery conveyor under the action of gravity. Alternatively, or additionally, the delivery conveyor may comprise a vertically displaceable or a variably inclinable conveyor belt section. The accumulation unit is preferably controllable to drive the belt of one shelf at a time only.

In order to expedite processing of arriving luggage or parcels, the control system may be configured to assign, to each of the items, a particular branch of the delivery conveyor, before the items are being offloaded from the at least one cart.

The item accumulation unit may be a mobile unit, or it may be immobilized relative to the at least one item conveyor. In a presently preferred embodiment of the second aspect of the invention, the item accumulation unit is immobilized, so that it remains in a fixed position relative to the sorting conveyor or the delivery conveyor.

Preferred embodiments of the second aspect of the invention comprise a plurality of accumulation units for departing items and a plurality of accumulation units for arriving items.

Disclosed herein is also a cart, which is able to conveniently handle odd-size and oversize items.

The cart for transport and storage of items may preferably comprise:
a chassis comprising a plurality of wheels;
a storage section comprising at least one shelf;
a drawer below the storage section, the drawer comprising a compartment which is inaccessible when the drawer is in a closed state, in which the drawer is overlapped by a bottom portion of the storage section, and wherein the compartment is accessible when the drawer is an open state, in which the drawer is extracted from and extends beyond the bottom portion of the storage section.

A method for transport and storage of items by means of the above cart comprises the steps of: loading a first group of said items onto the at least one shelf of the storage section;
loading at least one further item into the compartment of the drawer when the drawer is in the open state, said at least one further item being sized and shaped so that it does not fit into the compartment when the drawer is in the closed state; and transporting the items by means of said cart while the drawer remains in the open state.

Odd-size and over-size items which do not fit onto the shelves of the cart, or which are otherwise not suited for accommodation by the shelves (“out of Gauge”), may be placed in the drawer, when the compartment is accessible, i.e. in the open state of the drawer. In the closed state of the drawer, it is preferably overlapped, most preferably completely overlapped, by the bottom portion of the storage section of the cart, so that the drawer does not occupy space or provide an obstacle when it is not being used. Hence, the drawer provides a space and structure for accommodating items when need, and when no such space and structure is needed, the drawer is conveniently stowed away underneath the storage section.

Generally, the storage section and the at least one shelf thereof may be sized and configured to accommodate items having a dimension or volume not exceeding a first maximum dimension or a first maximum volume, and the compartment may be sized and configured to accommodate odd-size items having a dimension or volume exceeding the first maximum dimension or the first maximum volume.

As will have become apparent from the above description, the first group of items accommodated by the shelves of the cart may comprise air passenger luggage, and said at least one further item may comprise odd-size or oversized air passenger luggage. The cart of the present invention is in particular suited for transporting items, such as luggage items, from an aircraft to a luggage conveyor of an airport, or from a luggage sorting conveyor of the airport to the aircraft. Other fields of use are envisaged, such as for example uses for food items, such as dairy or bakery products, notably in the field of retail distribution of goods in warehouses, grocery stores or supermarkets.

In order to couple the cart to an identical one to form a train of carts, a connecting element may be provided at the cart, the connecting element having a free end, which is configured to connect to the other cart. The connecting element preferably extends from the chassis of the cart below the drawer in the direction of extraction of the drawer, with the free end of the connecting element extending beyond the drawer when the drawer is fully extracted. The connecting element may hence couple to the next cart even when the drawer is open to allow the cart to be driven in a train of carts with the drawer in the open state. In an alternative embodiment, a front end of the cart may comprise a front connector, and the rear end of the cart may comprise a rear connector for connecting to the front connector or an identical cart, whereby the front connector and the rear connector together have a length exceeding the length of the drawer when extracted.

In one embodiment of the invention, the bottom portion of the storage section of the cart comprises a planer bottom surface, which is inclined relative to horizontal, in which case the drawer preferably comprises correspondingly tapering side structures, so as to allow the drawer to be accommodated in a safe-spacing manner below the storage section.

The at least one shelf may preferably comprise a plurality of shelves arranged in rows and columns. Each of the shelves may be inclined relative to horizontal, so as to thereby define an upper end and a lower end, the upper end of each shelf being arranged at a loading end of the cart, and the lower end of each shelf being arranged at an unloading end of the cart.

Disclosed herein is also a system comprising at least one cart and an accumulation assembly for loading items on to the cart or for accepting items offloaded from the at least one cart, the at least one cart comprising:
a chassis comprising a plurality of wheels;
a storage section comprising at a plurality of shelves arranged in rows and/or columns to form a first matrix pattern;
wherein the accumulation assembly comprises a plurality of shelves arranged in rows and/or columns forming a second matrix pattern, and wherein
each one of the shelves the first and second matrix patterns lies approximately flush with one of the shelves of the other one of the first and second patterns when the at least one cart is in a predetermined parking position relative to the conveyor assembly. In the present the term ‘approximately flush’ should be understood to mean that each of the shelves of the first matrix pattern forms a continuation of a mating one of the shelves of the second matrix pattern or vice versa.

Thanks to the mating matrix structures of shelves of the cart and the conveyor assembly, items may be loaded onto the at least one cart and offloaded therefrom in an automated manner, preferably without manual labour intervention. For offloading of items from the shelves of the cart, items may be offloaded under the action of gravity when the shelves are inclined, or they may be offloaded by movement of belts or other conveyor means on-board the cart. For loading of items onto the cart, the aforementioned on-board conveyor means may be applied, and/or conveyor means, such as belts, of the conveyor assembly may bring about the required transfer of the items from the conveyor assembly onto the shelves of the cart.

The at least one cart may, for example, include a cart as disclosed and claimed in international patent publication No. WO 2008/020084. In another embodiment, the at least one cart includes a cart according to the first aspect of the present invention.

### BRIEF DESCRIPTION OF THE DRAWINGS

Embodiments of the invention will now be further described with reference to the accompanying drawings, in which:

FIGS. 1-44 relate to embodiments of the second aspect of the invention as claimed in appended claim 16;

FIGS. 45-51 disclose variations of the connecting conveyor shown in FIGS. 24-44;

FIGS. 52-81 relate to embodiments of the first aspect of the invention as claimed in the appended claims 1-15.

### DETAILED DESCRIPTION OF THE DRAWINGS

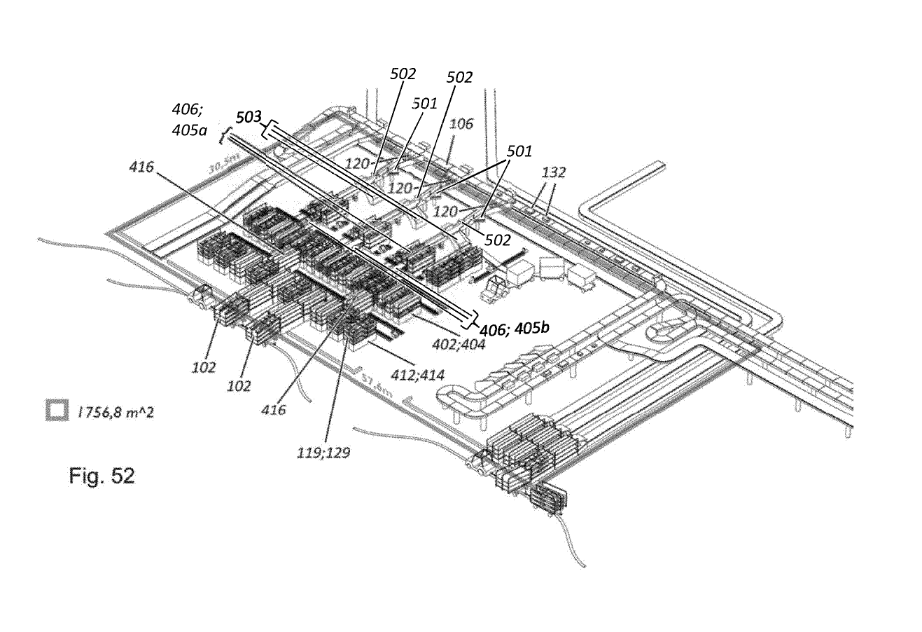

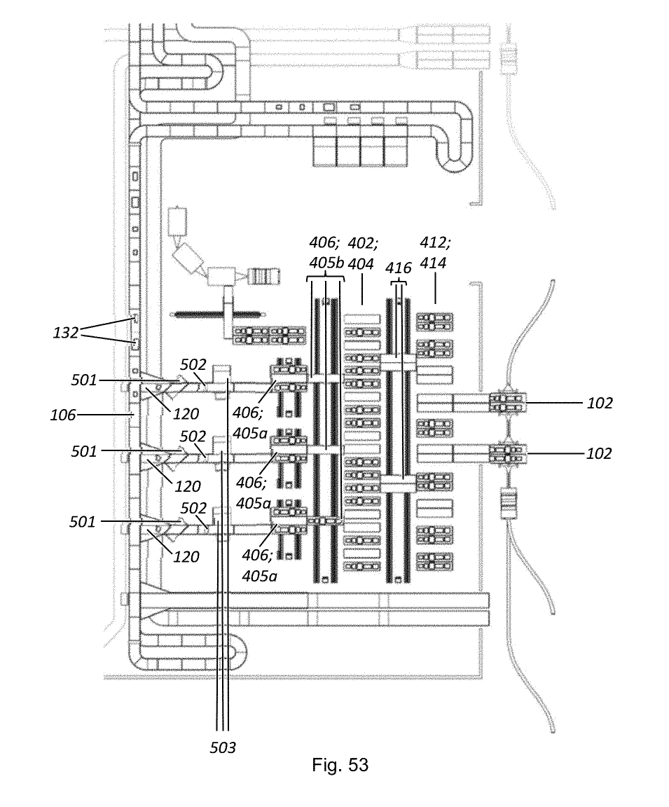

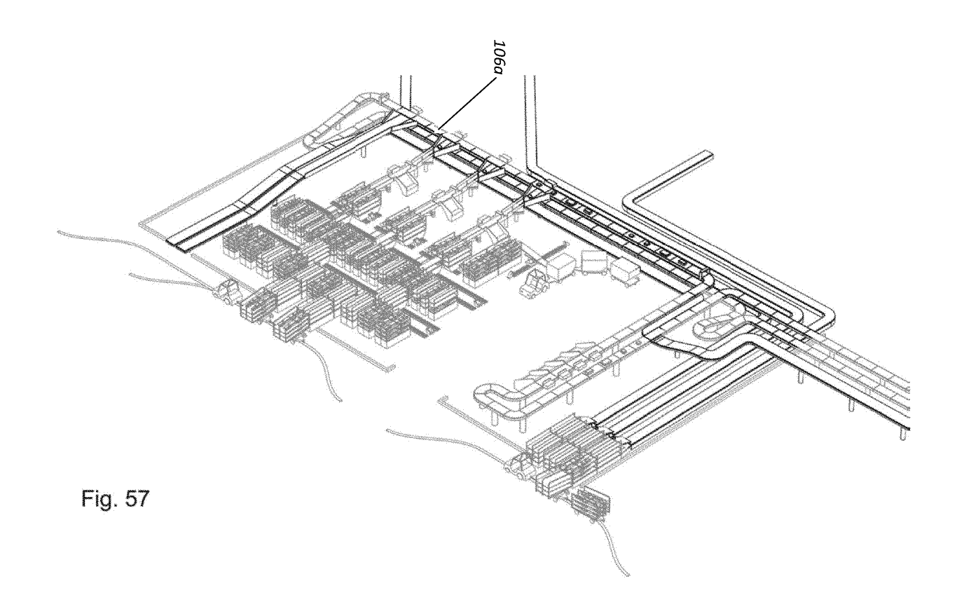

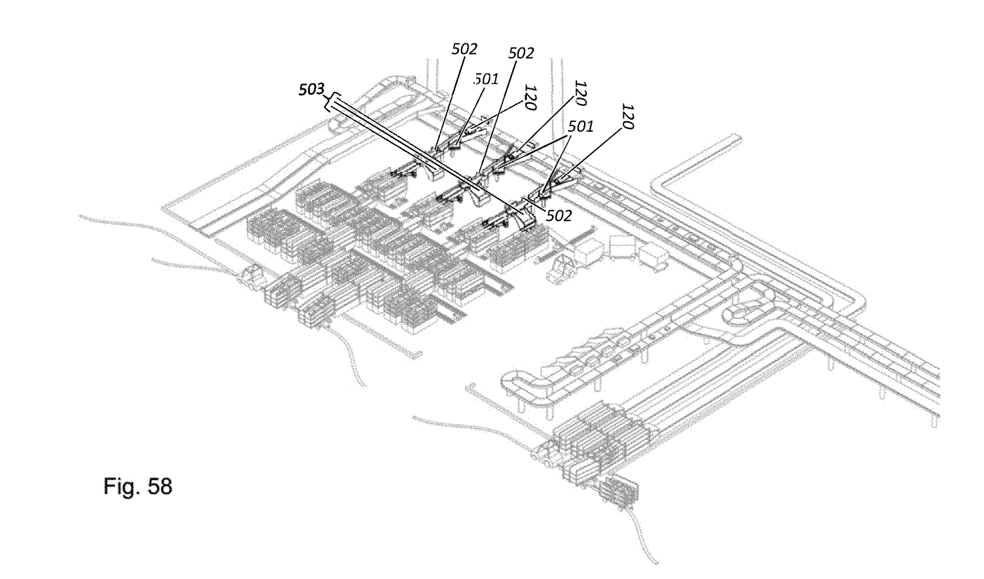

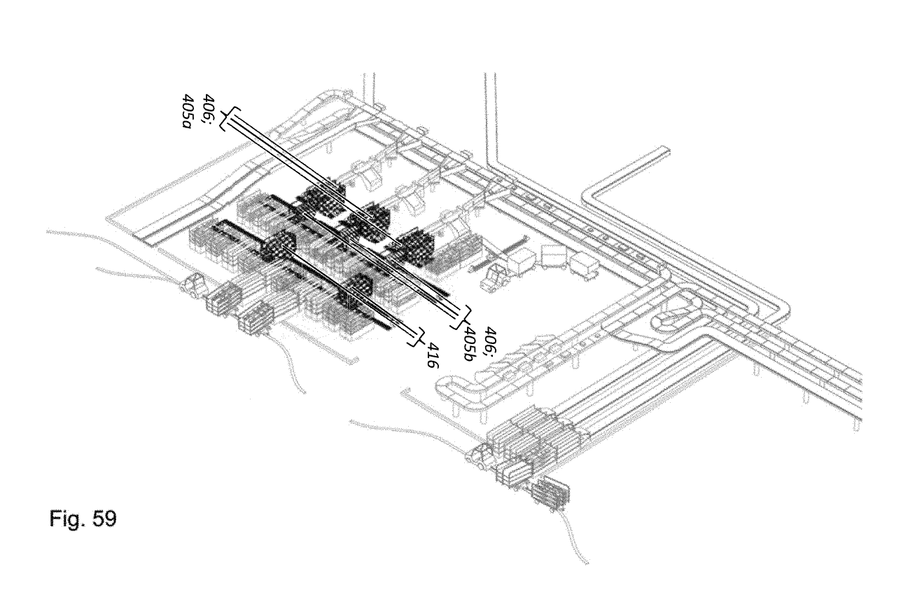

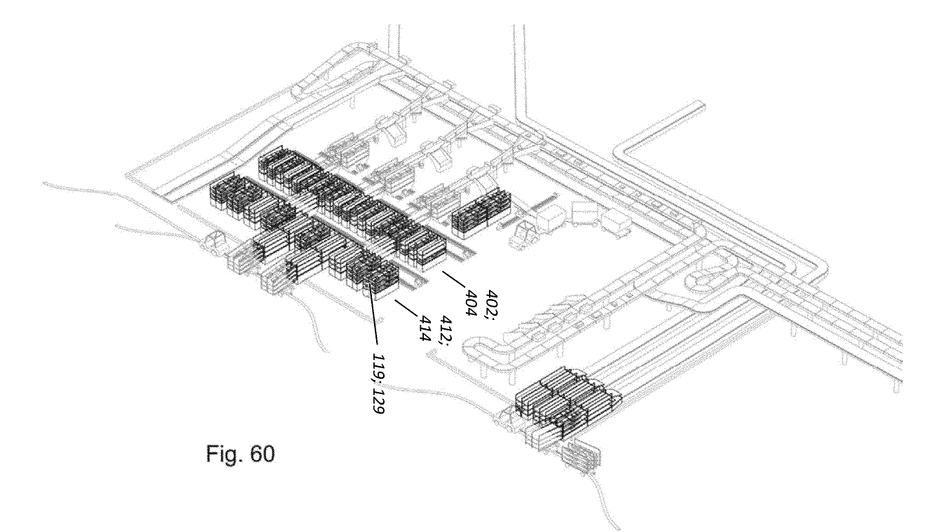

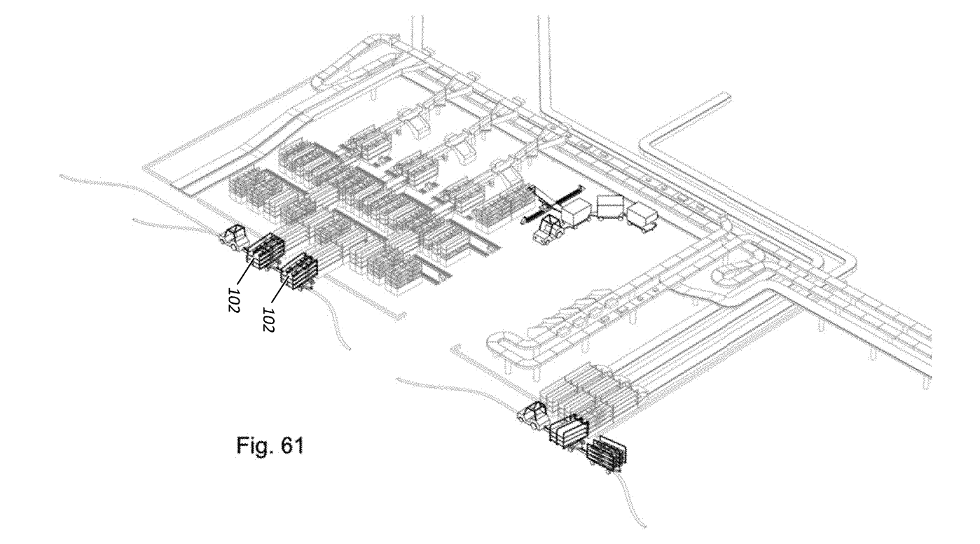

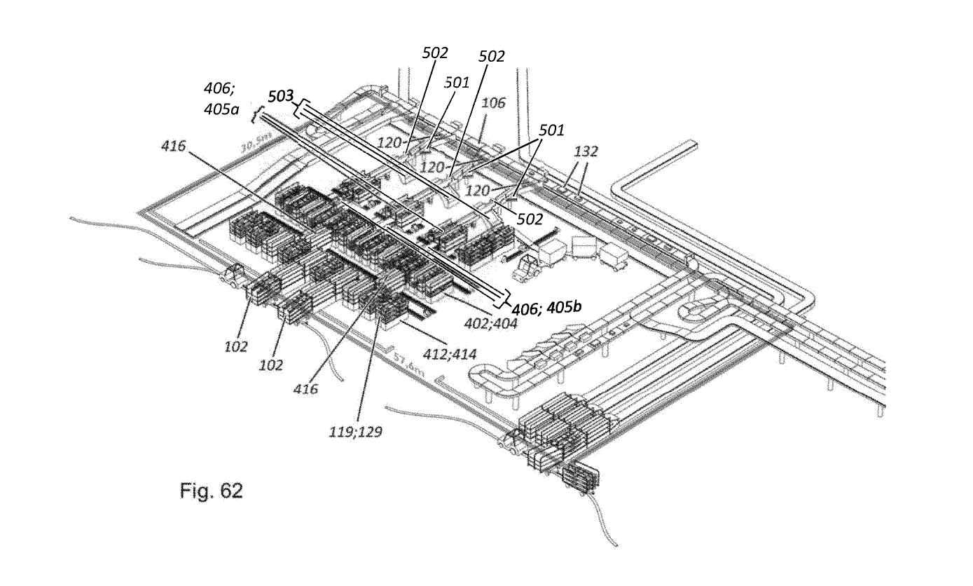

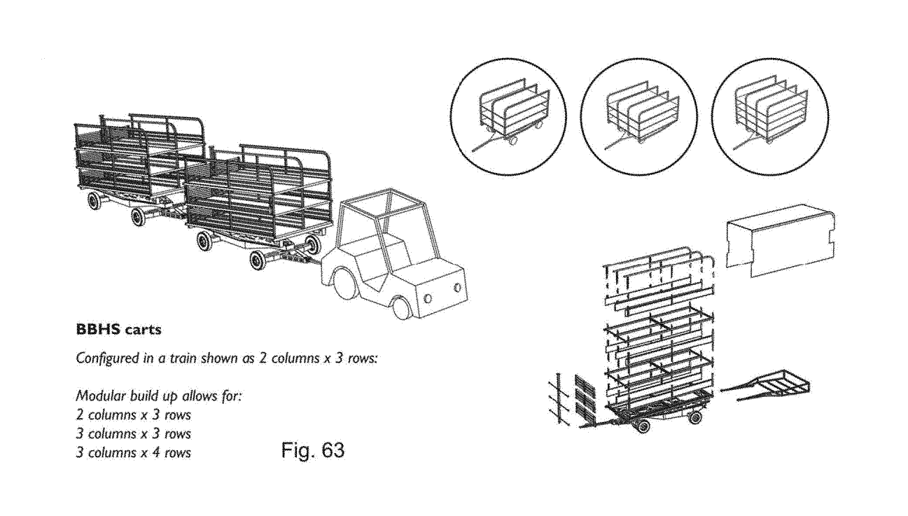

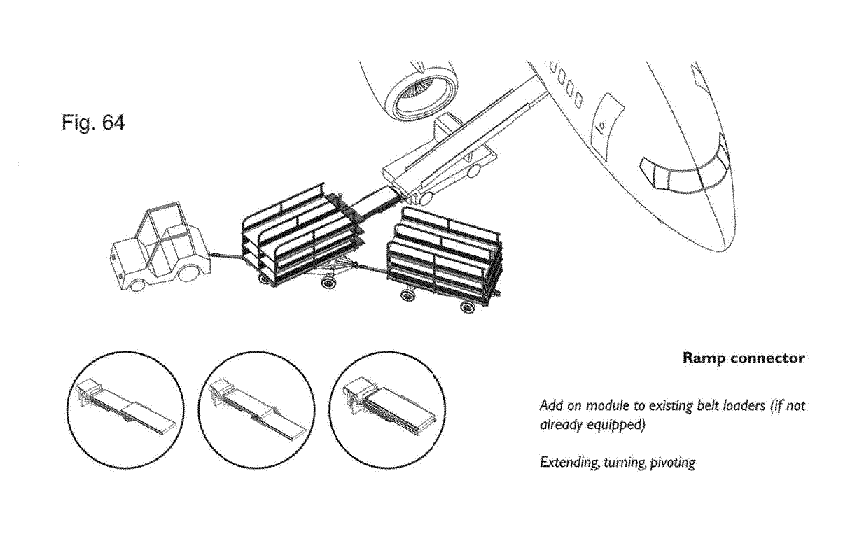

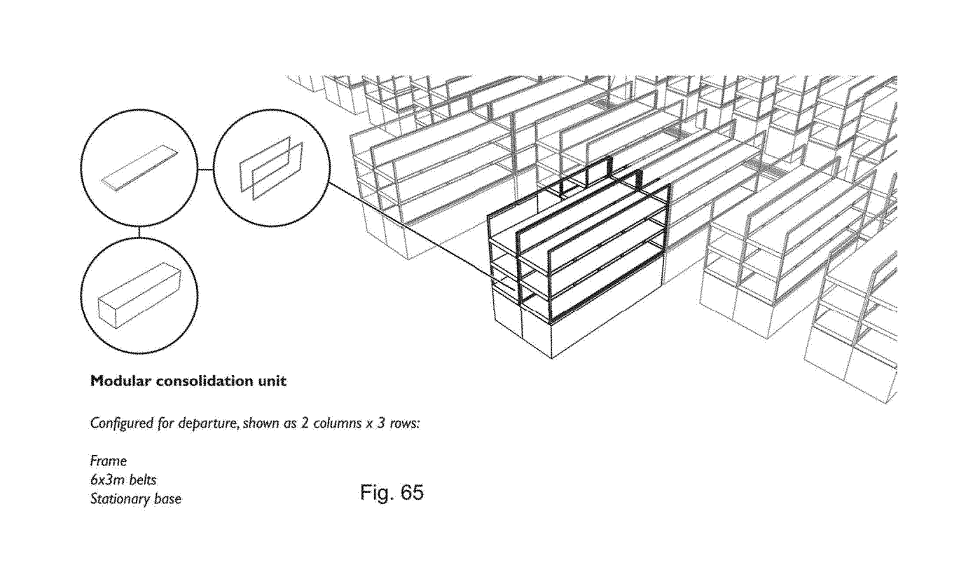

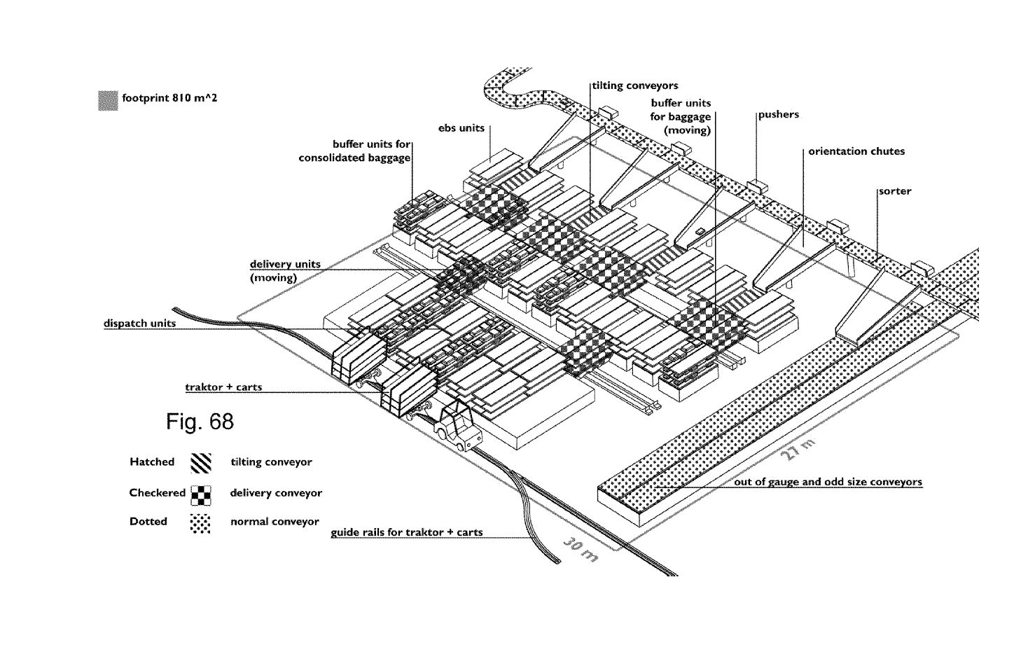

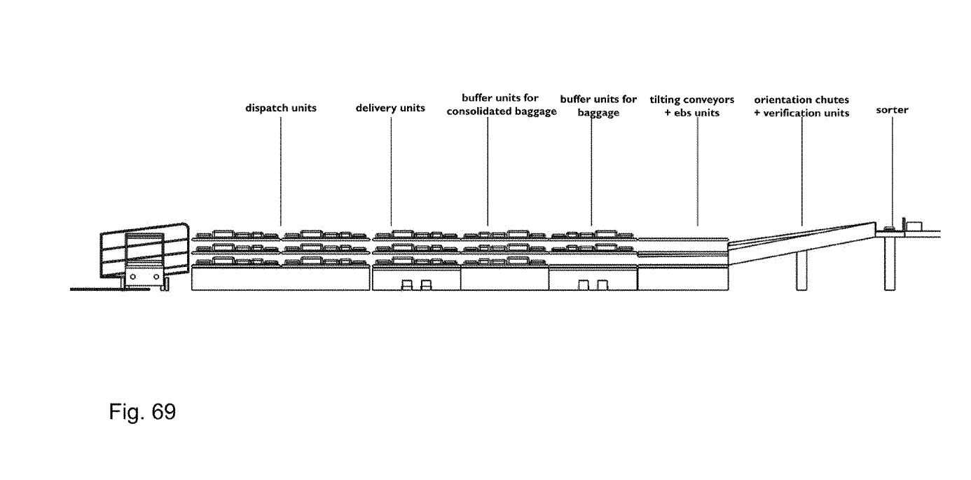

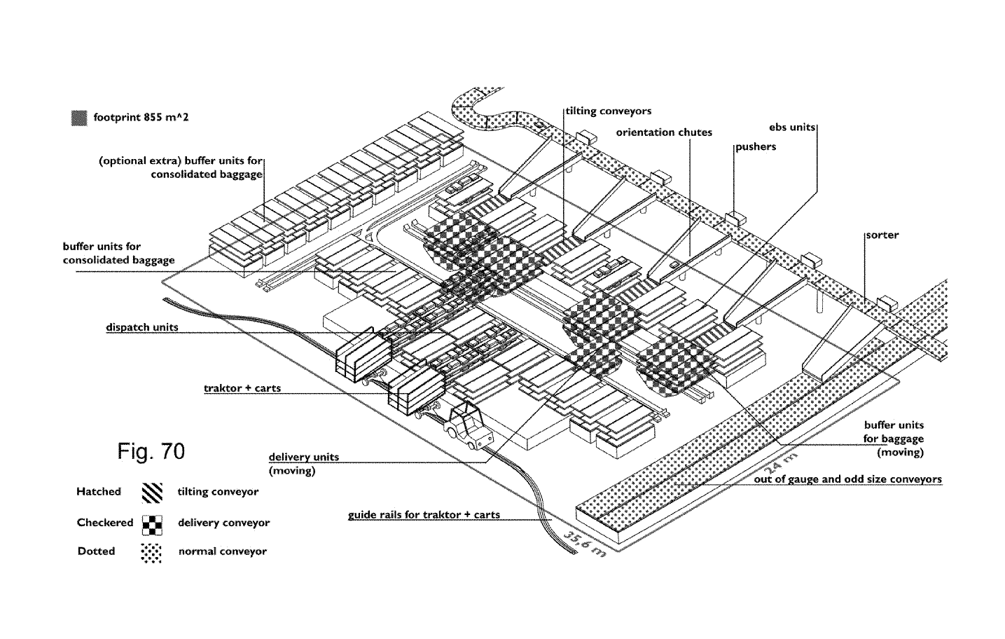

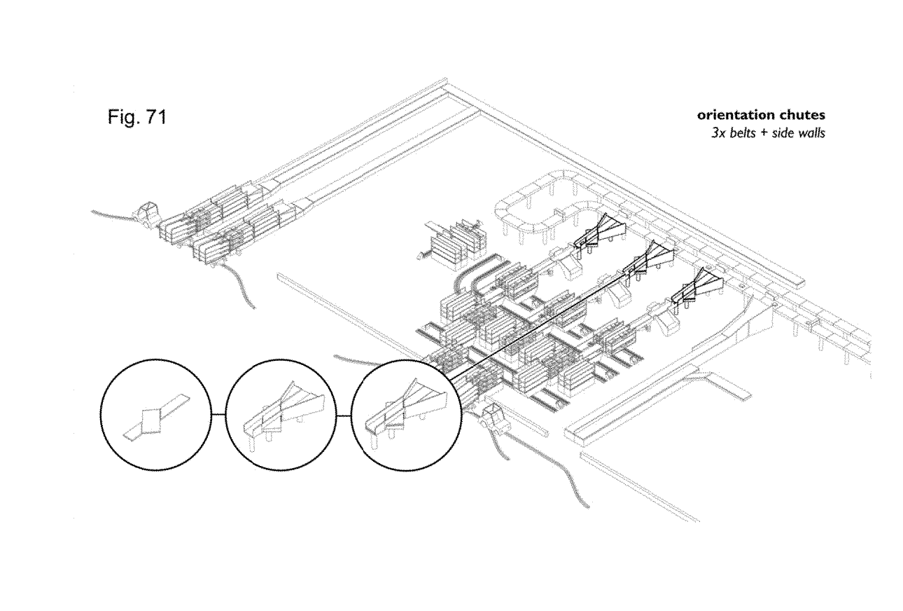

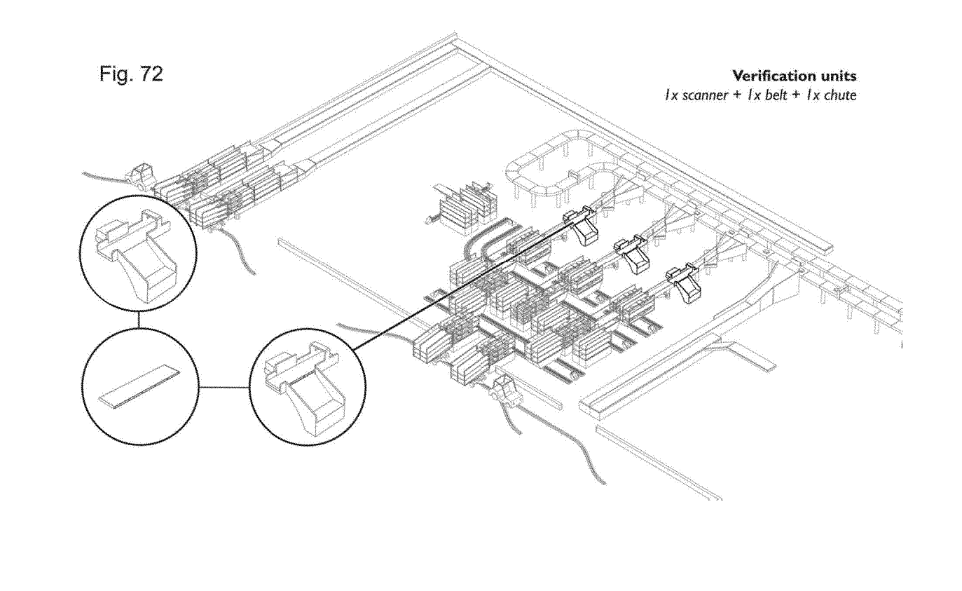

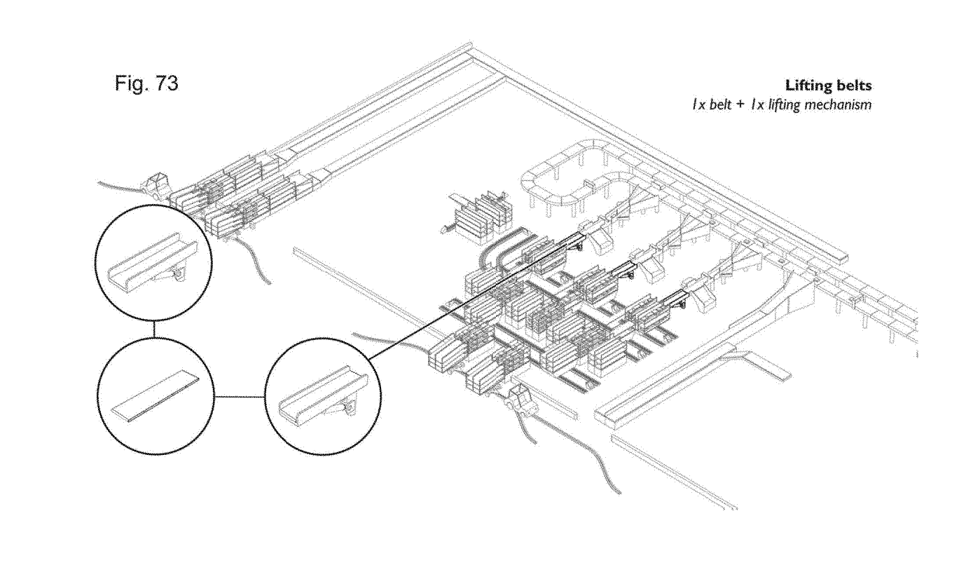

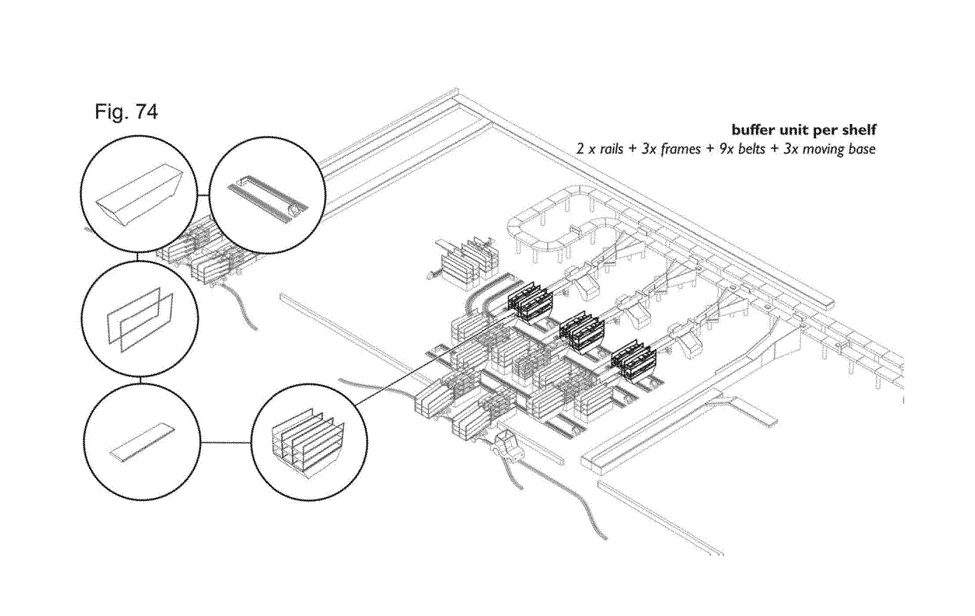

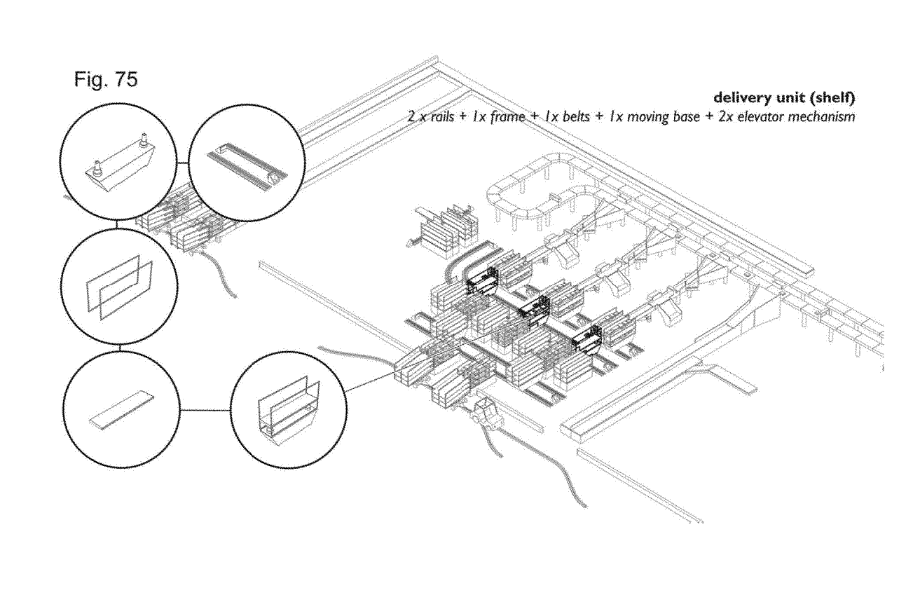

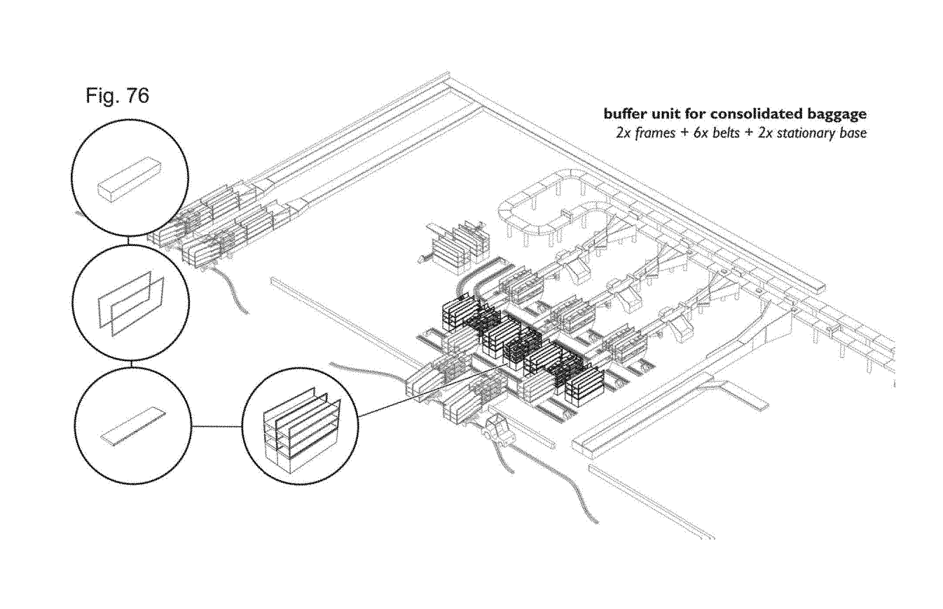

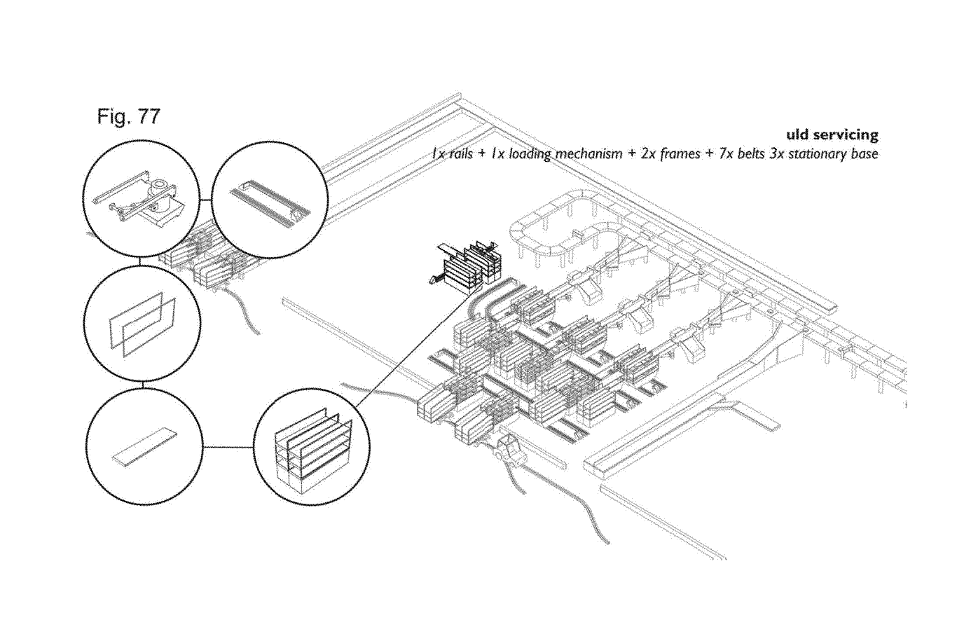

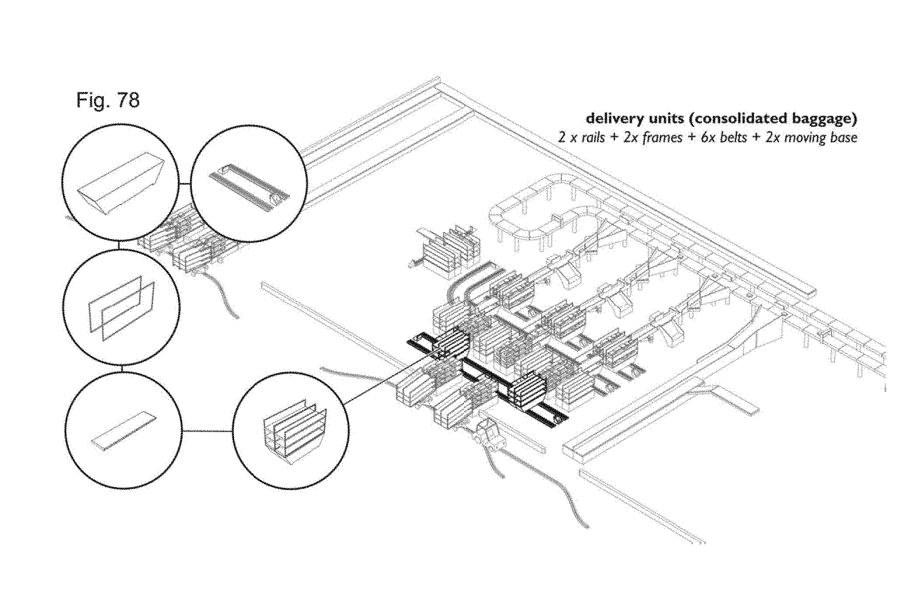

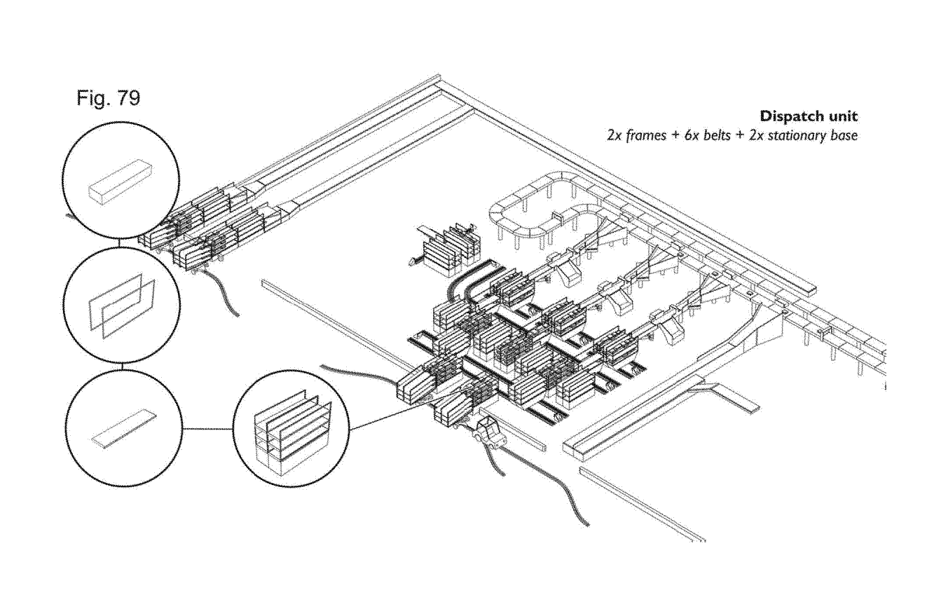

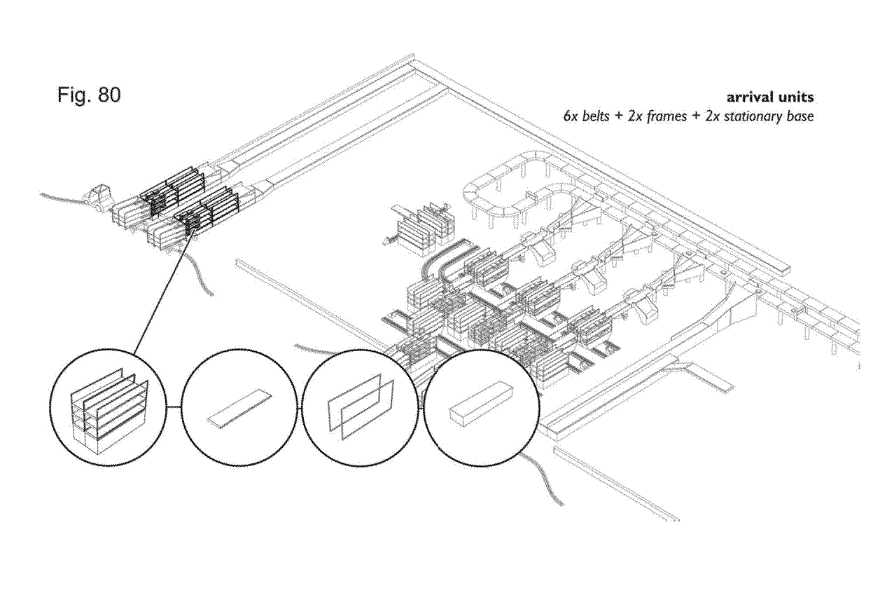

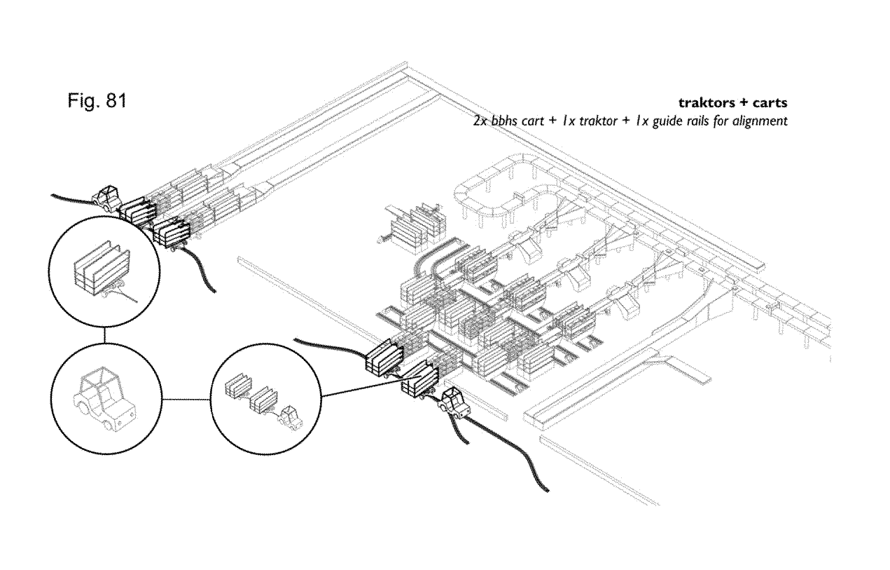

Referring initially to FIGS. 52-81, disclosed therein are embodiments and features of the system according to the first aspect of the invention. The system comprises a principal conveyor 106 for conveying the items to respective unloading positions 120 along the principal conveyor 106. A first item buffer section 402 comprises a number of first item accumulation units 404 arranged at the unloading positions 120 of the principal conveyor 106. Each of the first item accumulation units 404 comprises a plurality of shelves 119, 129 for storing a plurality of items 132 on each shelf 119,129, each shelf extending in a longitudinal direction from an inlet end of the first item accumulation unit 404 to an outlet end thereof. A directing apparatus 406 is provided at each unloading position for directing the items onto the shelves 119, 129 of the first item accumulation units 404. A second item buffer section 412 is provided, comprising a number of second item accumulation units 414, wherein each of the second item accumulation units 414 also comprises a plurality of shelves 119, 129 for storing a plurality of items 132 on each shelf, each shelf extending in the longitudinal direction from an inlet end of the second item accumulation unit to an outlet end thereof. An item transfer apparatus 416 receives items 132 unloaded from the first item accumulation units 404 at their unloading ends, and loads the items 132 unloaded from the first item accumulation units 404 onto the second item accumulation 414 units at their loading ends. From the unloading ends of the second item accumulation units 414, carts 102 carts are able to receive items 132. Each second item accumulation unit 414 has shelves that corresponds to shelves on the carts 102 so that all shelves of the second item accumulation unit 414 is able to deliver items 132 to individual shelves and columns of the carts 102. Operation of the item transfer apparatus 416 is controlled by a control system, so as to distribute the items unloaded from the first item accumulation units 404 among the second item accumulation units 414.

In the embodiment shown in FIGS. 52-62, the directing apparatus 406 comprises shelf buffering units 405a and elevator shelf delivery units 405b. The shelf buffering unit 405a comprises a single row of shelves 119, 129 and acts as a buffer between the unloading position 120 and the elevator delivery unit 405b. The elevator delivery unit 405b delivers items from the single level shelf buffering unit 405a to any of the shelves 119, 129 of the first item accumulation units 414. Furthermore, the system according to this embodiment comprises item orientation units 501 that mechanically orient items 132 delivered at the unloading positions 120. The orientation units 501 orient the items 132 according to a specified range of orientations to suit the shelves 119, 129 of the system. Verification units 502 detects the orientation of items 132 passing through it by means of e.g. lasers. Items 132 with an orientation within the range of specified orientations are conveyed to the directing apparatus 406. Items 132 with other orientations are discharged at discharge stations 503 where a pusher 134 pushes items off the conveying belt and into chutes for pick-up.

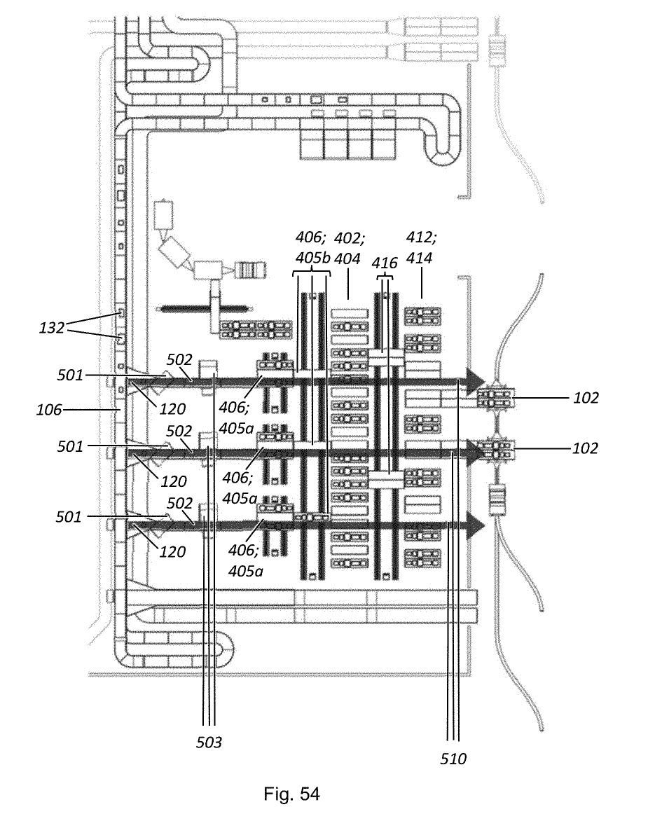

In FIG. 54, three arrows 510 indicate the general conveying direction from the unloading positions 120 to the unloading ends of the second accumulation units 414.

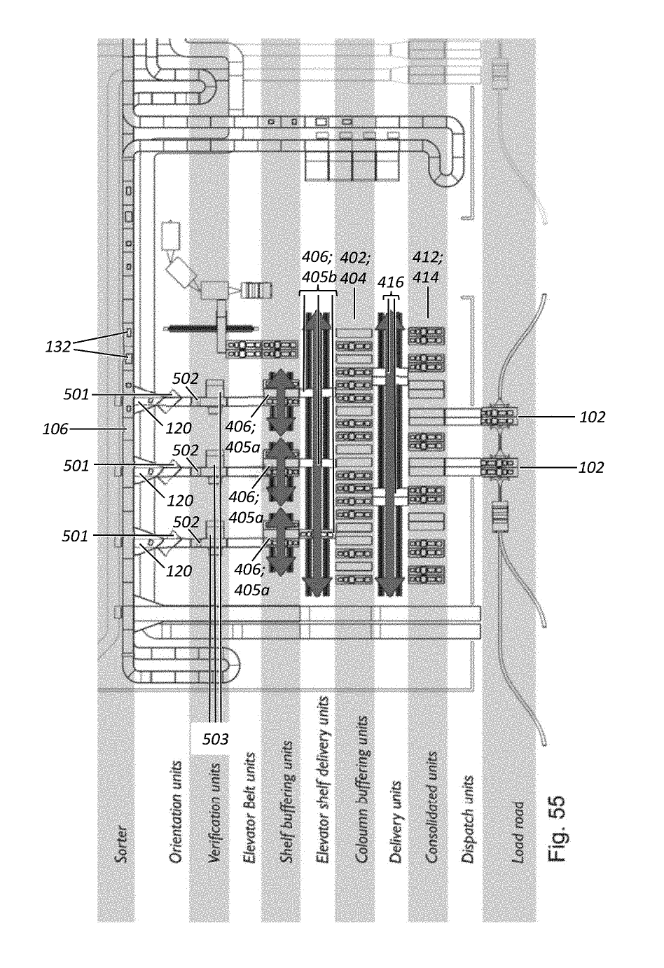

In FIG. 55, arrows indicate that the directing apparatus 406 in the form of shelf buffering units 405a and elevator shelf delivery units 405b are movable in a direction transverse the general conveying direction indicated in FIG. 54. Moreover, each item transfer apparatus is transversely movable only in a space between successive items accumulation units. Accordingly, item transfer apparatuses only move in directions transverse the general conveying direction, that being side to side and/or up and down relative to the general conveying direction.

Furthermore, in FIG. 55 the principal conveyor 106 is referred to as sorter. The first item accumulation units 404 are referred to as column buffering units, and the item transfer apparatus 416 are referred to as delivery units. The second item accumulation units 414 are referred to as consolidated units.

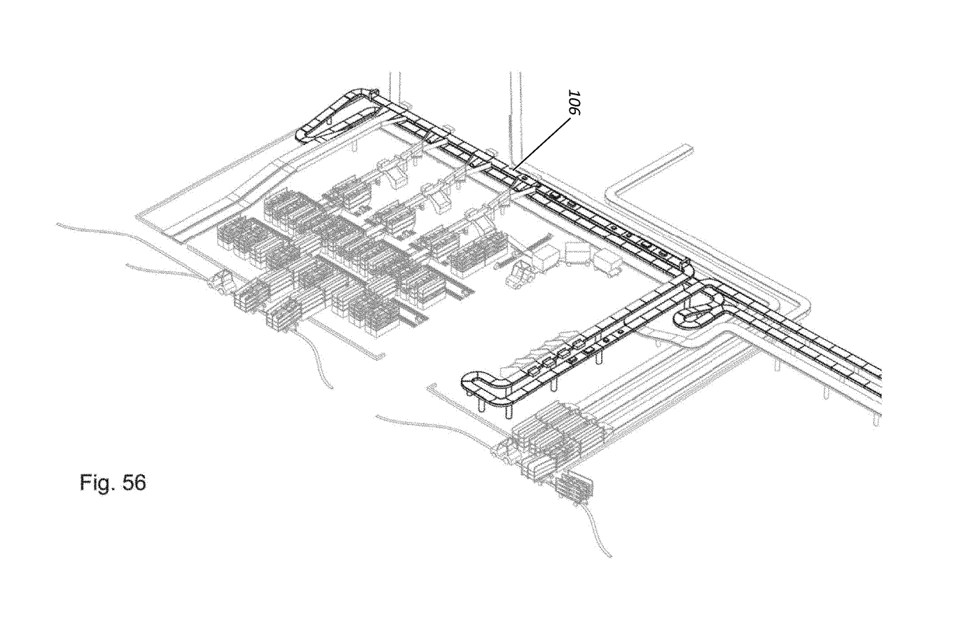

FIG. 56 to FIG. 61 each highlights individual components of the item handling system.

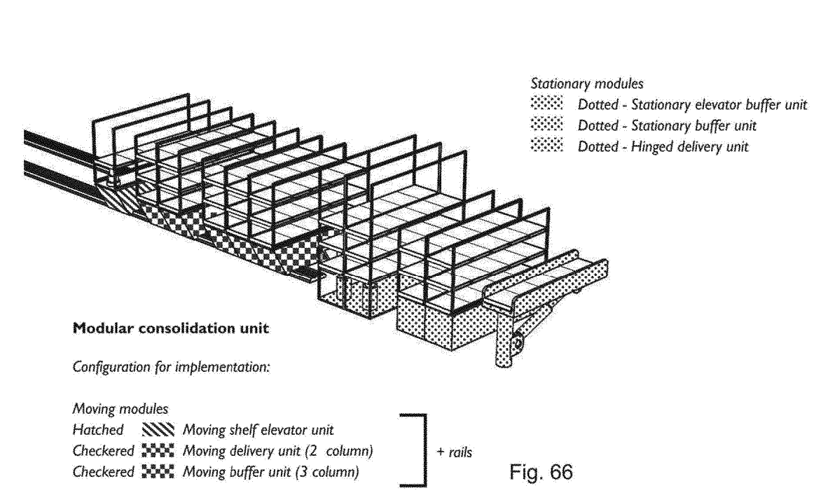

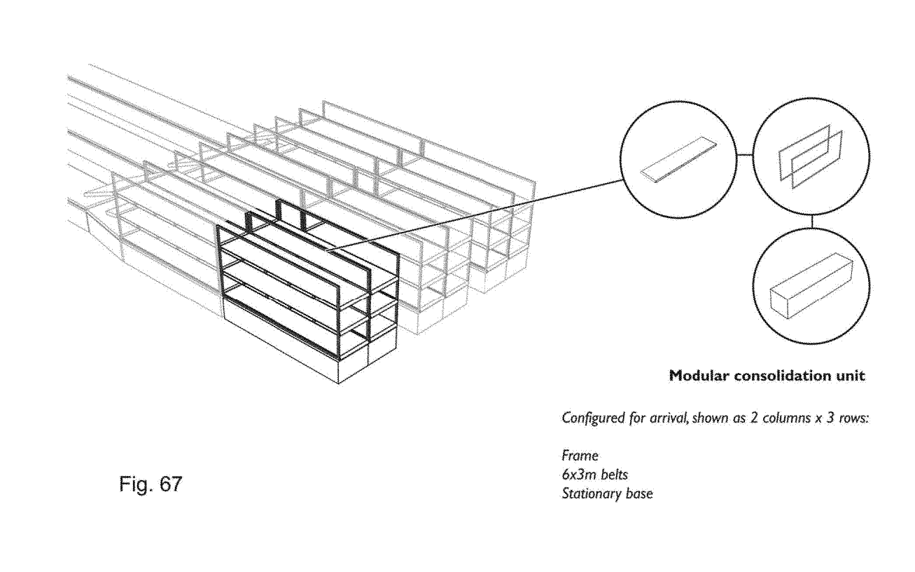

FIGS. 66 and 67 illustrate that each of the item accumulation units, the item transfer apparatus, and the buffer units may include a plurality of identical building block elements in a modular building component system.

Compliance determination means are provided for determining each item's 132 geometrical compliance and/or its orientation compliance with the item accumulation units, and deflection means are provided at 420 (FIG. 56) for deflecting non-compliant items, i.e. out-of gauge items, away from the first item accumulation units, so as to prevent the non-compliant items from being loaded into the item accumulation units, the deflection means being arranged between the unloading position at the principal conveyor and the first item accumulation unit.

The item accumulation units at dispatch stations form a row of dispatch units, which in the embodiment of FIG. 52 are embodied by the second accumulation units 414. A plurality of wheeled carts 102 is provided, each cart comprising a chassis and a storage section comprising a plurality of cart shelves for accepting items unloaded from the dispatch units, and wherein the storage section of each cart is rotatable relative to the cart's chassis around an upright axis.

It will be understood the features of the first and second aspects of the invention may be combined in common embodiments. In particular, the first and second item accumulation units 404, 414 of embodiments of the first aspect of the invention may be configured identically with—and/or embodied as—the item accumulation units 118, 122 of embodiments of the second aspect of the invention, comprising a plurality of accumulation shelves 119, 129 as discussed further below.

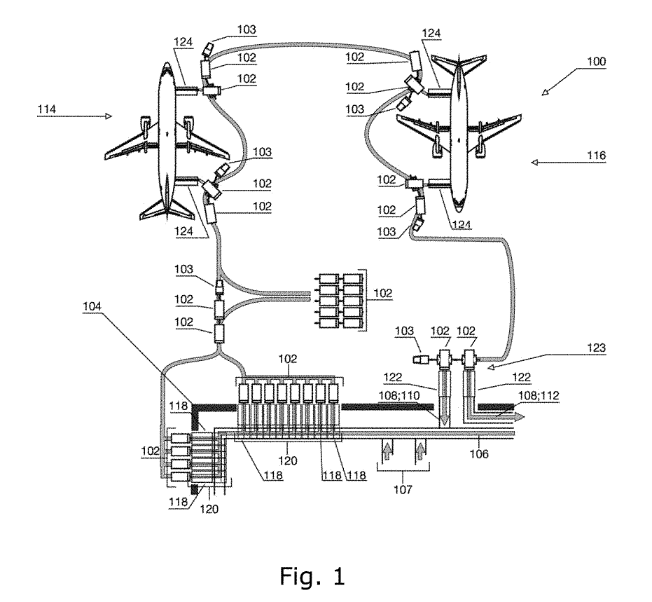

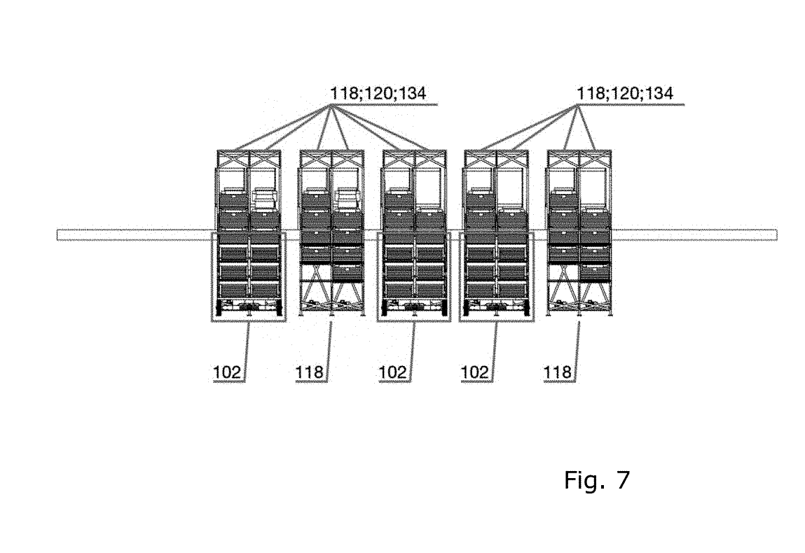

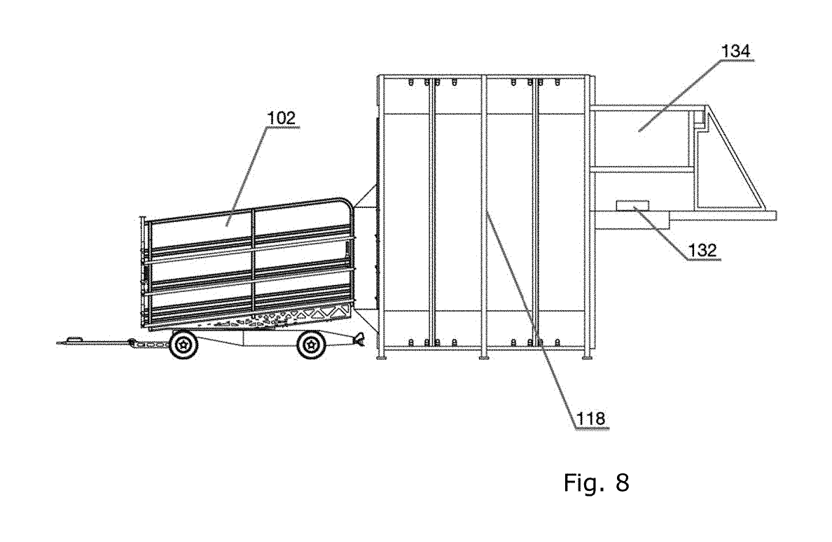

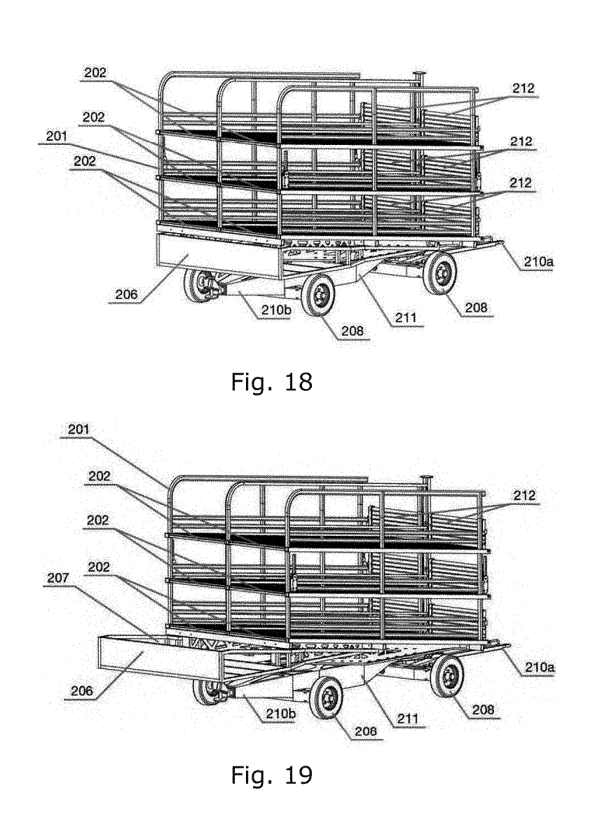

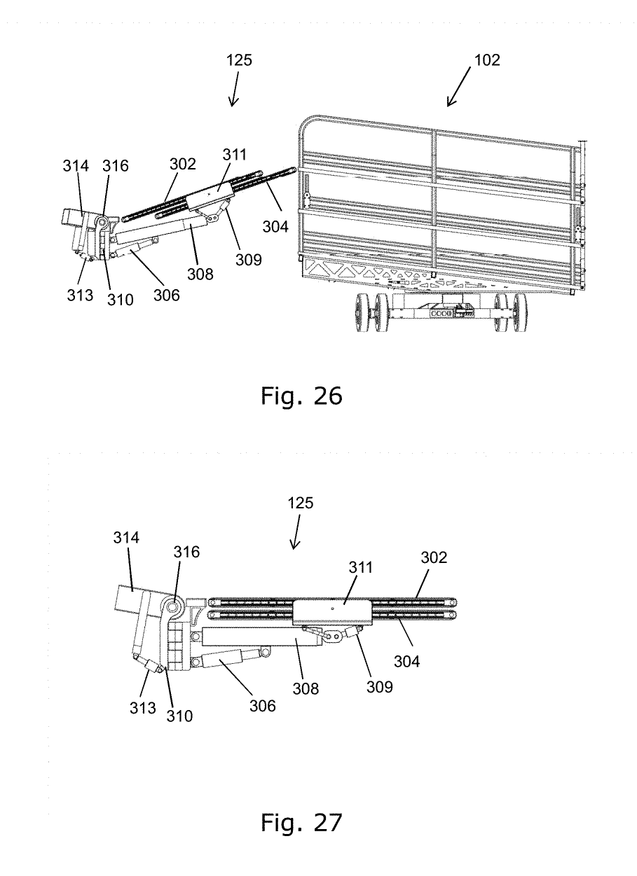

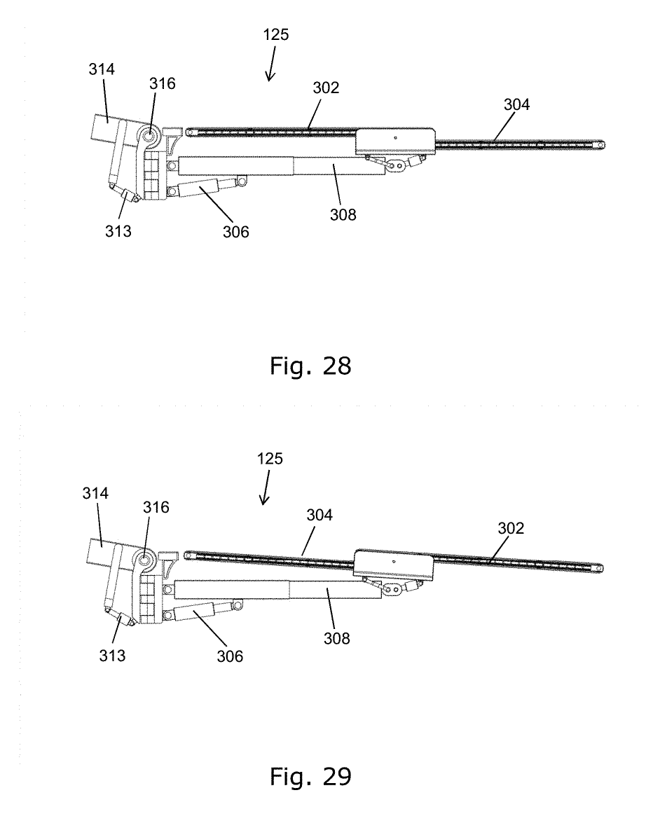

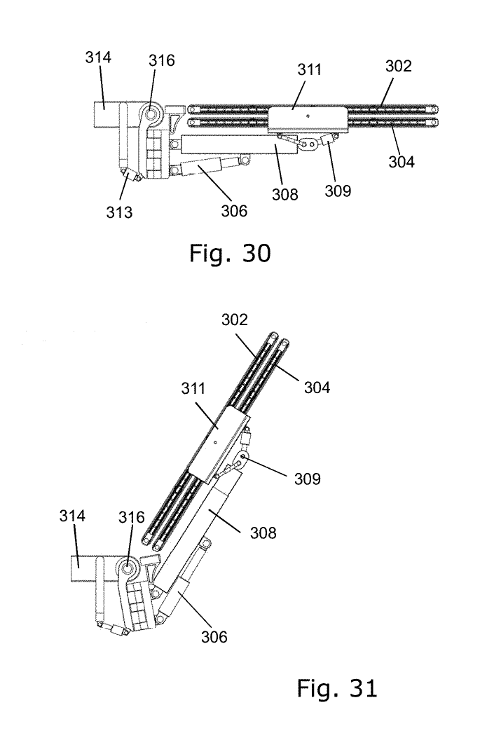

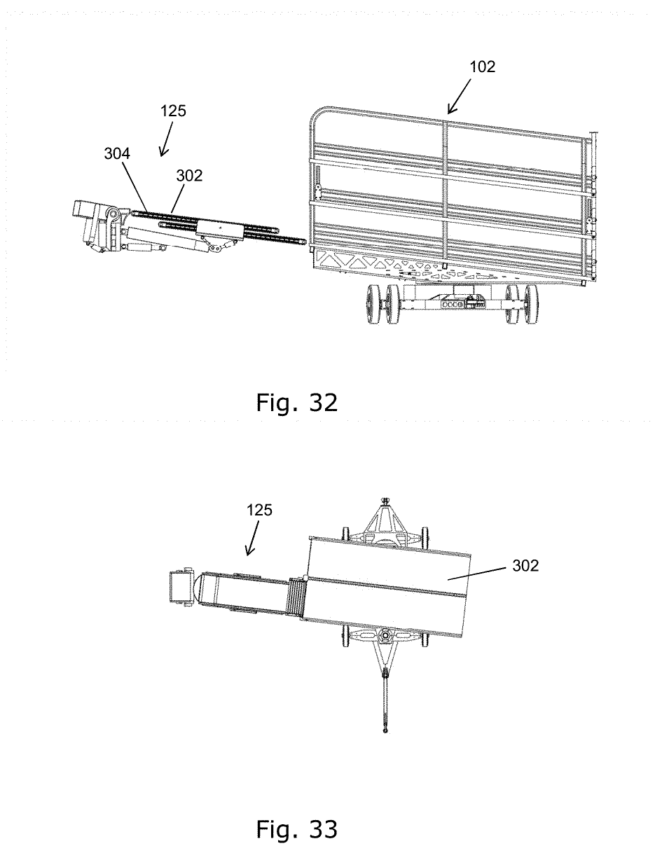

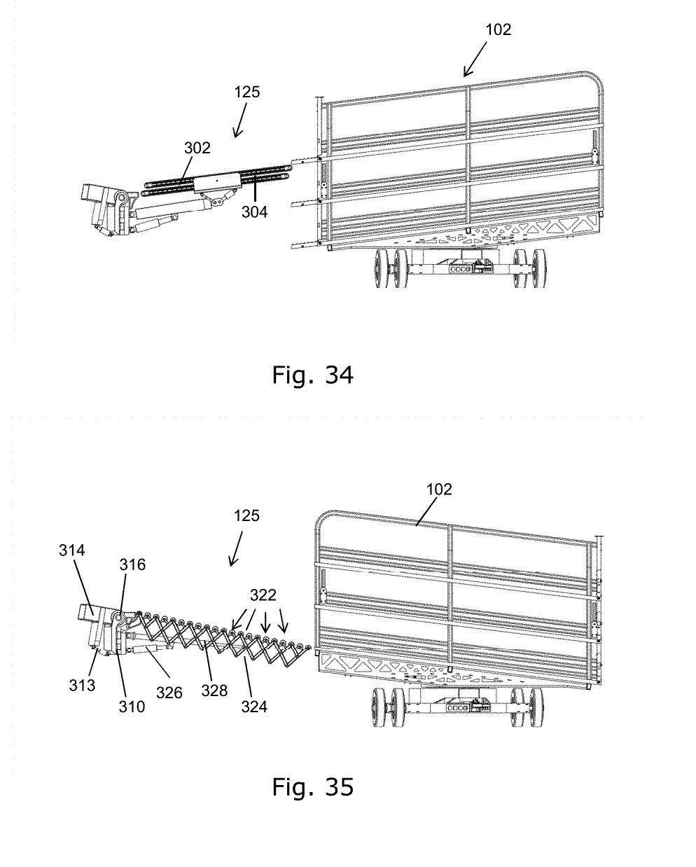

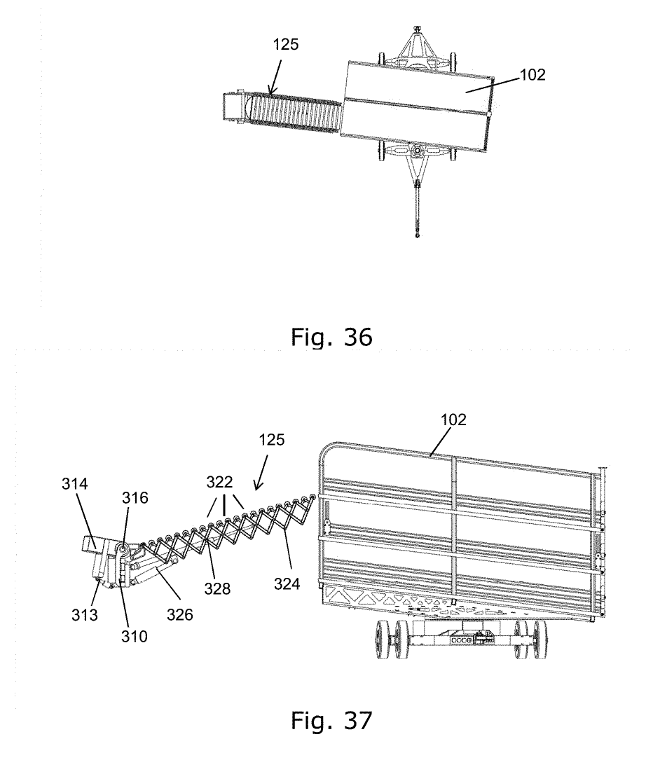

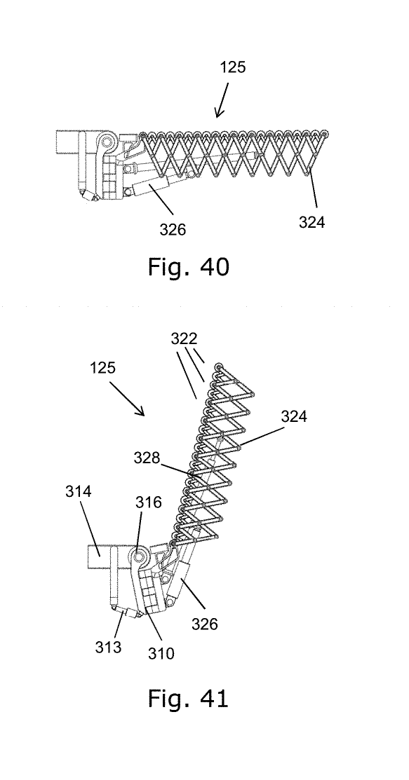

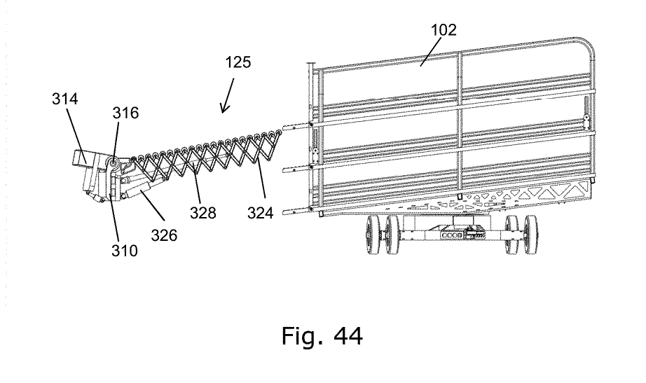

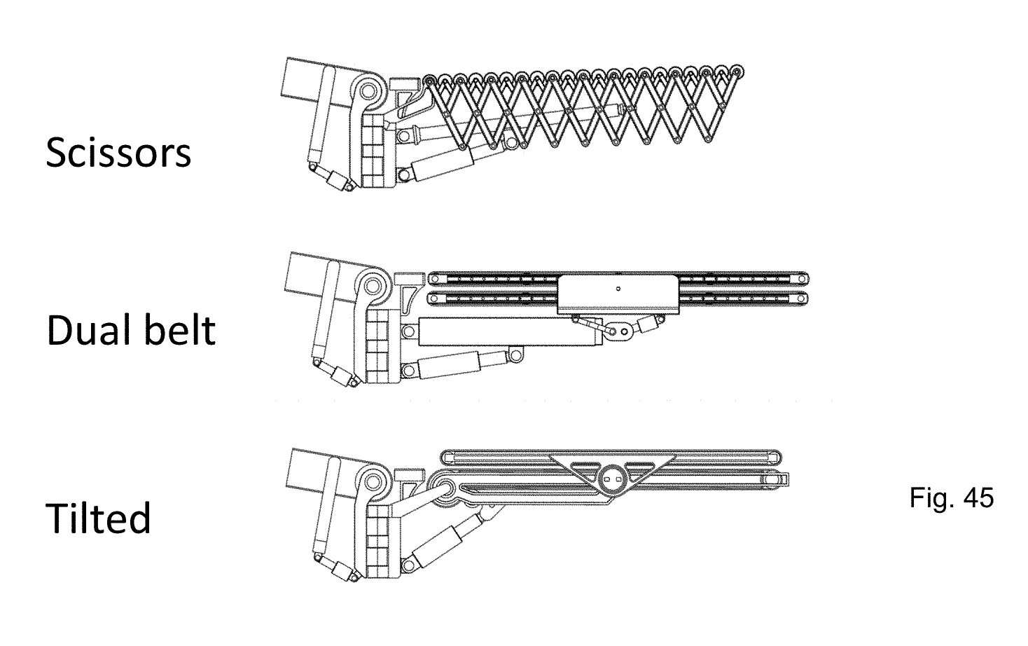

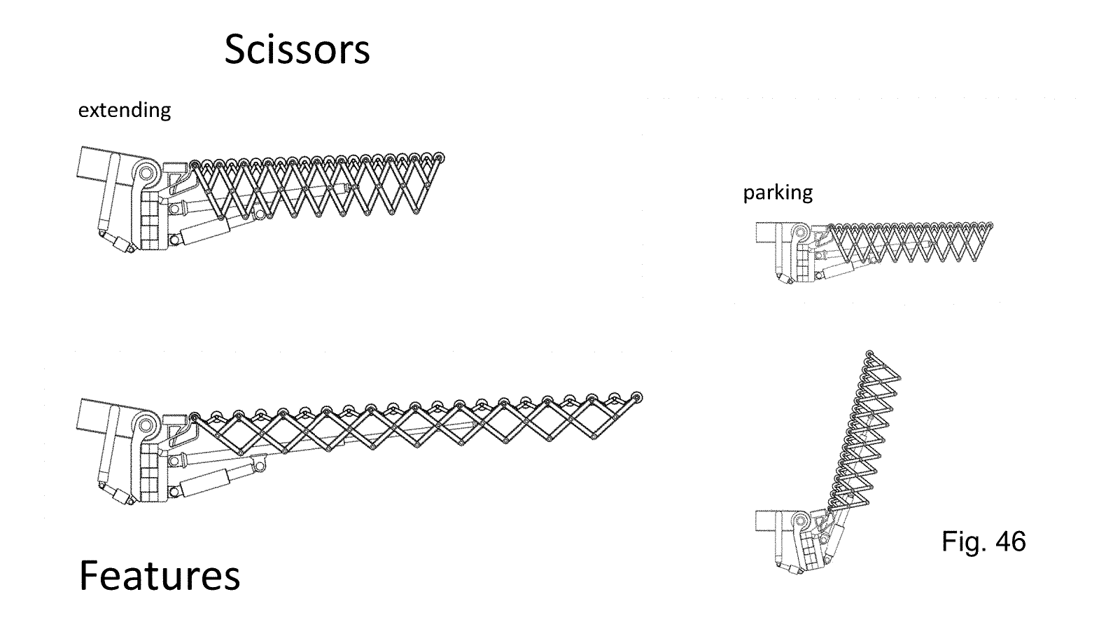

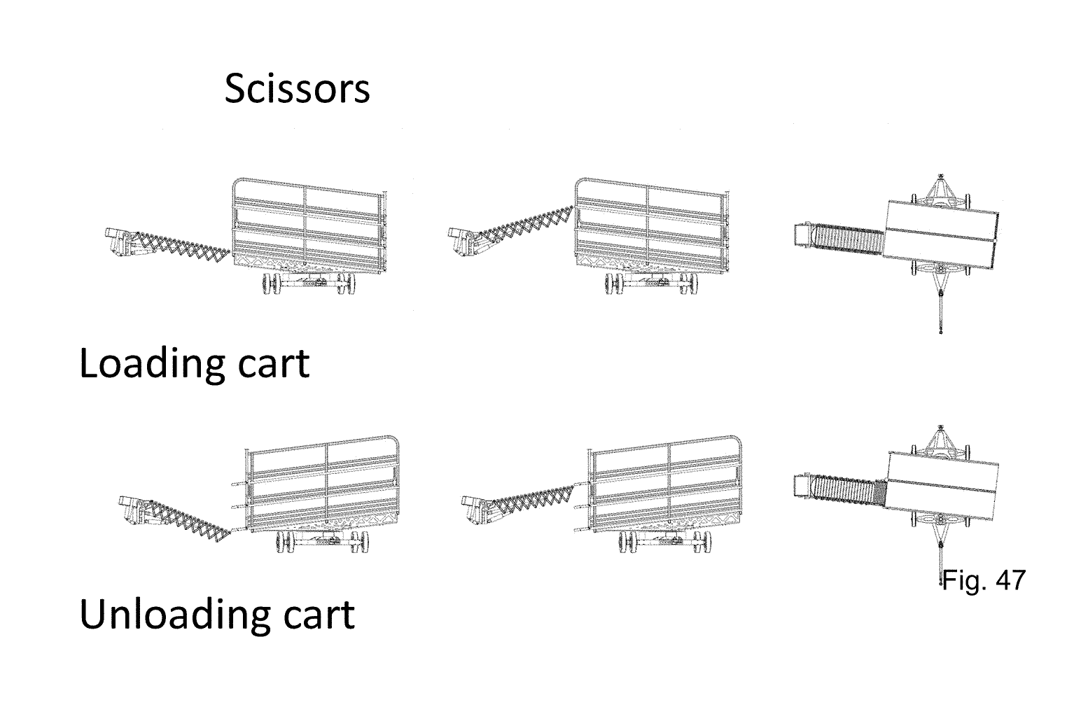

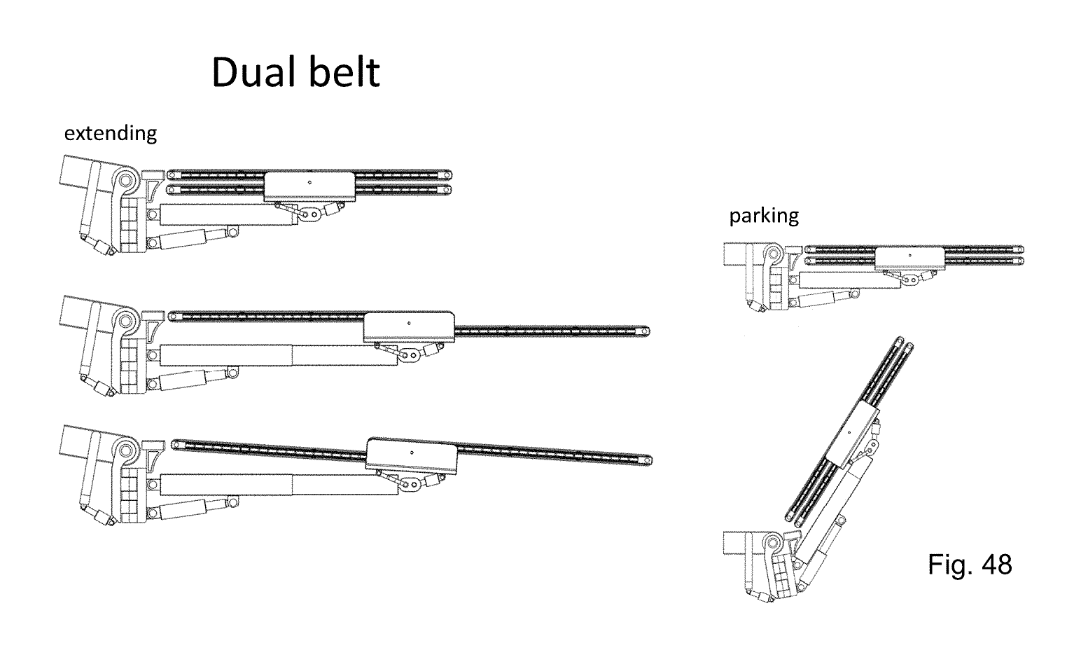

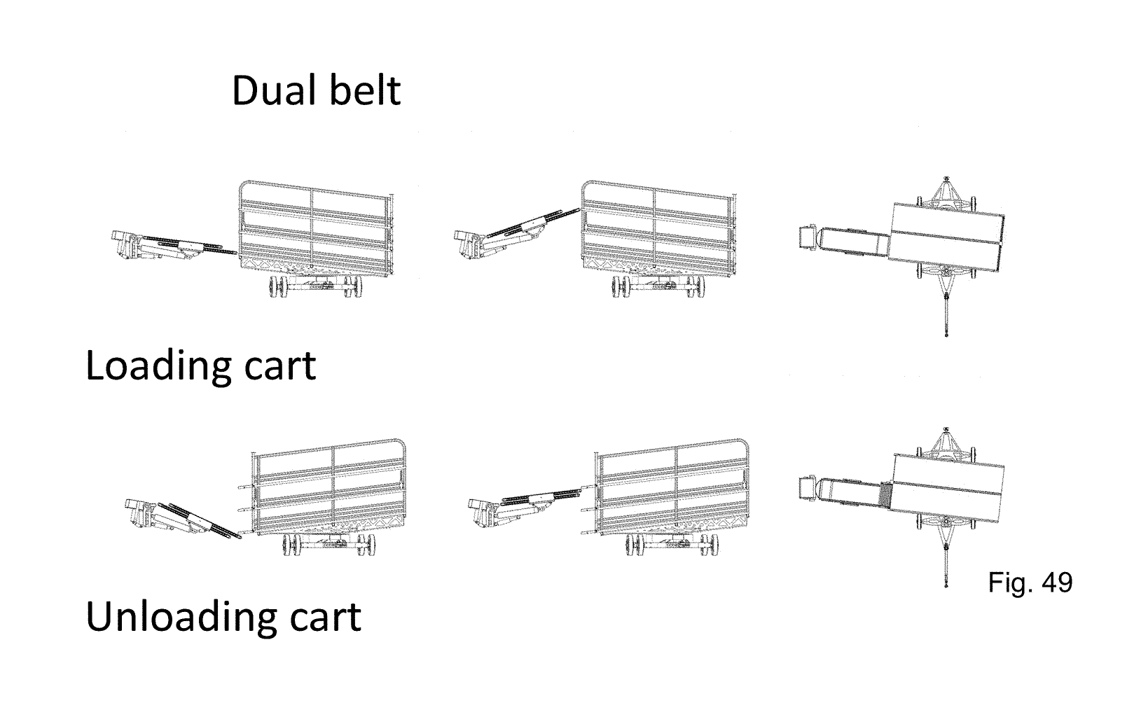

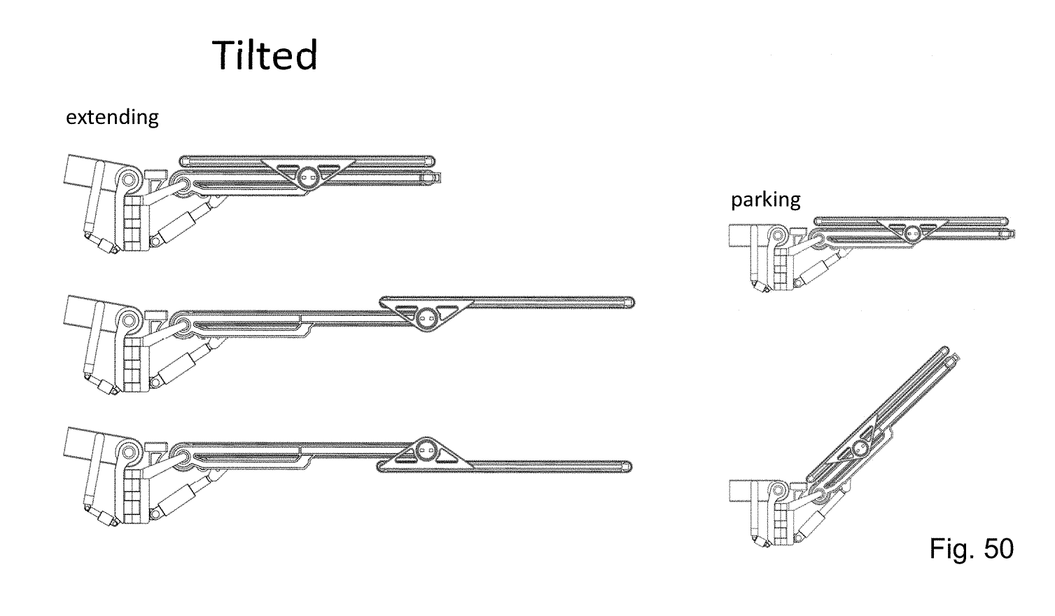

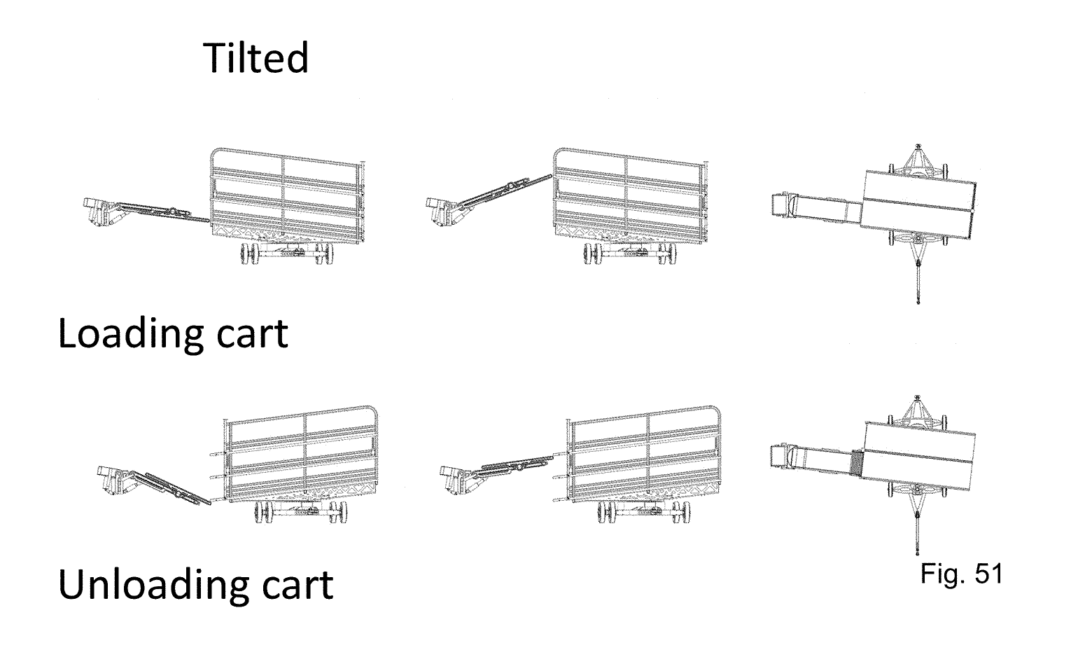

The embodiments of FIGS. 1-51 will now be further described.

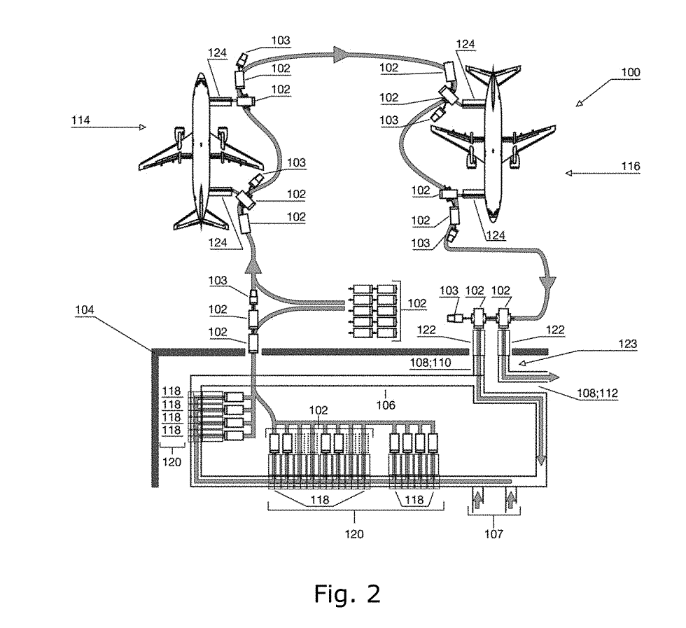

FIGS. 1 and 2 illustrate respective embodiments of a system 100 for handling of luggage or parcel items. The system 100 comprises a plurality of carts 102 which may be coupled to form train of carts driven by tractors 103. In the embodiment of FIG. 1, the carts 102 are operated solely outside of a sorting hall building 104, and do not enter the building, whereas in the embodiment of FIG. 2, the carts 102 are operated inside and outside of the sorting hall building 104. The carts 102 are utilized for transferring items, such as airport luggage or parcels, between an aircraft site 114 or 116 and an item conveyor, which either constitutes a sorting conveyor 106 for departing luggage or a delivery conveyor 108 for arriving luggage. The aircraft site may include a departing aircraft site 114 or an arriving aircraft site 116. The sorting conveyor 106 comprises sorter inlets 107, also referred to herein as sorting conveyor inlet positions, which are connected to a luggage check-in site of the airport. Alternatively, the sorter inlets may be connected to a transit conveyor 110 as described below. The delivery conveyor 108 comprises two branches 110 and 112, of which conveyor branch 110 connects to the sorting conveyor 106, and branch 112 connects to a luggage reclaim area.

At unloading positions 120 of the sorting conveyor 106, the system 100 comprises a plurality of departure accumulation units 118 for accumulating items discharged from the sorting conveyor 106. One of said carts 102 is parked in a parking position in extension of each departure accumulation unit 118 with a loading end of the cart 102 arranged to accept items from the departure accumulation unit 118. Once loaded, the carts 102 may be coupled together to form trains of carts, which may be driven to the departure aircraft site 114 by means of tractors 103.

Arriving items are transferred from the arrival aircraft site 116 by means of trains of carts 102 to arrival accumulation units 122 for accepting items unloaded from the carts 102 and for further transfer thereof to the sorting conveyor-connecting branch 110 or to the reclaim conveyor branch 112, or to a parcel distribution facility (not shown), or to a further conveyor (not shown). The arrival accumulation units are provided at delivery conveyor loading positions 123 as indicated in FIGS. 1 and 2.

Belt loaders 124 may be provided at the aircraft sites 114, 116 in order to facilitate transfer of the items from the carts 102 into the aircraft and transfer of the items from the aircraft into the carts 102, respectively.

As described further below, the carts 102 comprise a wheeled chassis and a storage section, wherein the storage section is rotatable by at least 90° relative to the chassis around a vertical axis, so as to conveniently allow the storage section of the cart to be oriented as desired relative to the departure accumulation units 118, relative to the arrival accumulation units 122, and relative to the belt loaders 124. In preferred embodiments, each shelf of the cart 102 is configured to cause items supported thereby to be displaced from a loading end of the cart towards an unloading end thereof, i.e. to transfer the items when supported by the shelf in a cart-internal transfer direction. Likewise, each accumulation unit 118 and 122 may be configured to cause items supported thereby to be displaced from a loading end of the accumulation unit towards an unloading end thereof, i.e. to transfer the items when supported within the accumulation unit 118, 122 in an accumulation unit-internal transfer direction. The belt loaders 124 are configured to transfer the items in a belt loader transport direction. For loading and unloading of the carts, the cart-internal transfer direction is conveniently orientable in parallel to the accumulation unit-internal transfer direction and to the belt loader transport direction, respectively.

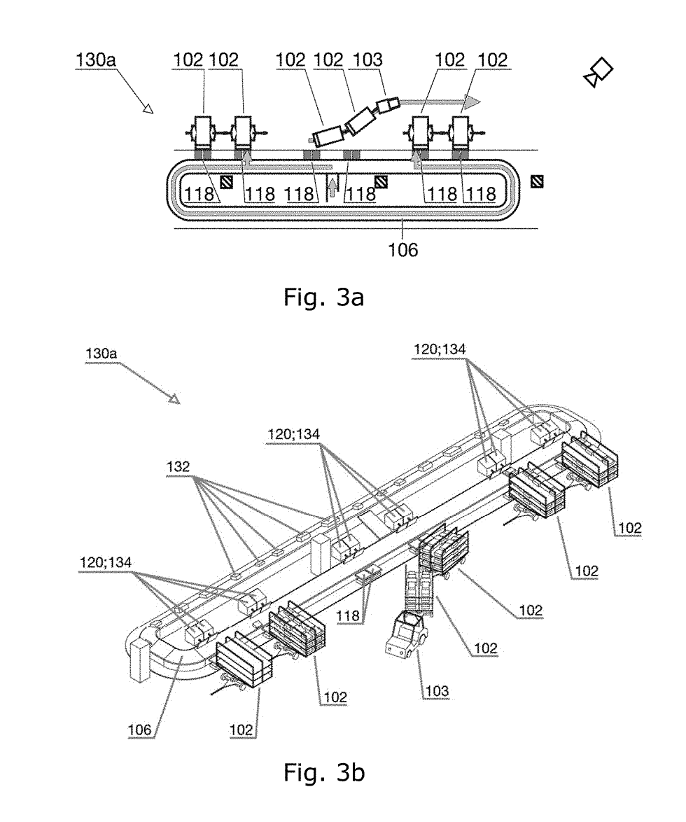

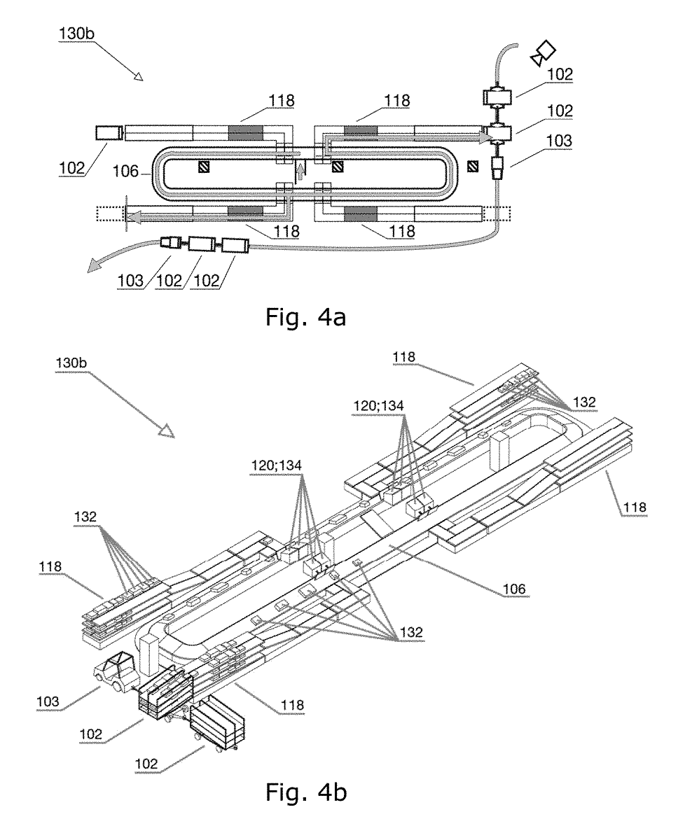

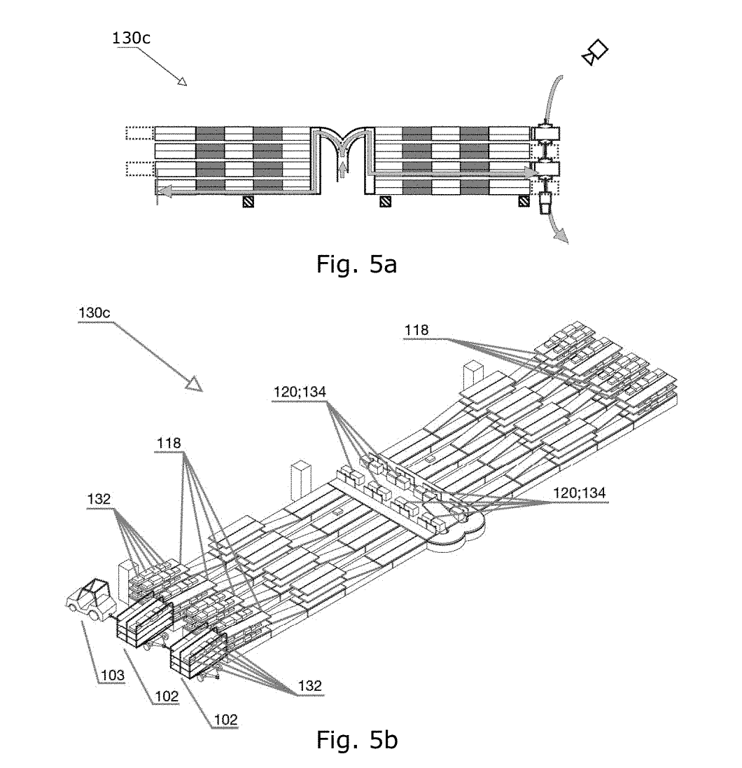

FIGS. 3a and 3b show a first layout 130a of a departure portion of the system 100. FIGS. 4a and 4b show a second layout 130b of the departure portion of the system 100, and FIGS. 5a and 5b illustrate a third embodiment 130c of the departure portion of the system 100. In each of the layouts 130a, 130b, 130c items 132, such as luggage or parcels, are conveyed along and sorted by sorting conveyor 106. Departure accumulation units 118 are provided at each unloading position 120, whereby the items 132 are buffered in the departure accumulation units 118 once discharged from the sorting conveyor 106 and before being loaded onto the carts 102.

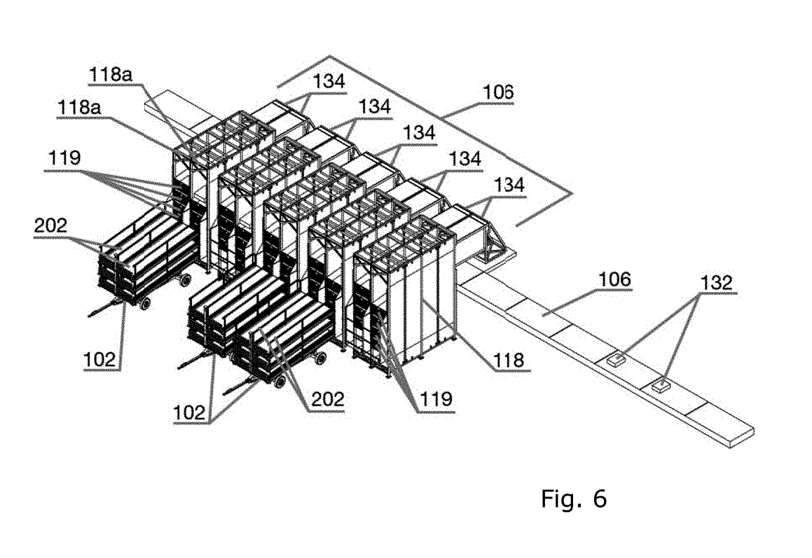

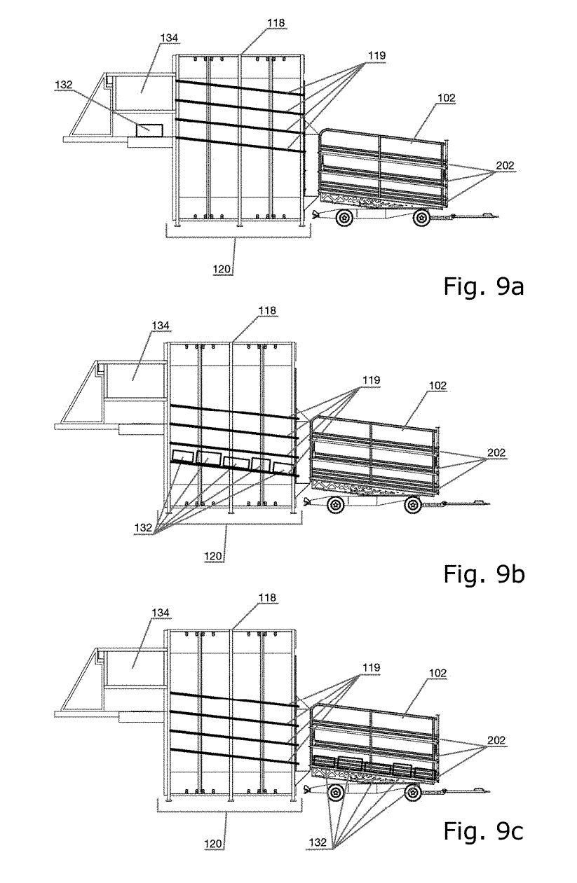

The departure accumulation units 118 and sorting conveyor unloading positions 120 are shown in further detail FIGS. 6-8 and 9a-9c. At each unloading position of the sorting conveyor 106, a pusher 134 is provided for discharging items 132 from the sorting conveyor 106 into the departure accumulation unites 118 in the direction of arrow 109 (see FIG. 9a). Operation of the sorting conveyor 106 and the pushers 134 is controlled by a control system (not shown), which discharges each of the items 132 into a departure accumulation unit assigned to a particular flight. For example, three of the five departure accumulation units 118 in FIG. 6 may be destined for a first departing flight, and the remain two accumulation units 118 may be destined for a second departing flight. The carts 102 are parked with their loading ends facing unloading ends of the departure accumulation units 118, whereby items 132 buffered by accumulation shelves 119 of the departure accumulation units 118 may be transferred to cart shelves 202 of each of the carts 102. Each departure accumulation unit 118 comprises a matrix structure of rows and columns 118a and 118b of a plurality of accumulation shelves 119. As shown in FIGS. 9a-9c, the accumulation shelves 119 of the departure accumulation unit 118 are permanently inclined, so as to enable items 132 supported by the shelves to be automatically displaced under the action of gravity from a loading end of each shelf towards an unloading end thereof. Each column of shelves 119 is preferably up- and downwardly displaceable as shown by the double arrow 121 in FIG. 9b. The vertical displacement 121 of each column of shelves 119 may be controlled by the control system of the sorting conveyor 106 and coordinated with the control of the operation of the pushers 134, so as to enable the selection of a particular shelf 119 for each item 132 discharged from the sorting conveyor 106 into the departure accumulation unit 118.

Once released from the departure accumulation units 118, the items 132 are allowed to slide onto the cart shelves 202 of each of the carts 102 under the action of gravity as indicated by arrow 111 in FIG. 9c.

It will be appreciated from the above description that the transfer of items from the sorting conveyor 106 onto the carts 102 may hence occur in a fully automated manner with no manual labour intervention.

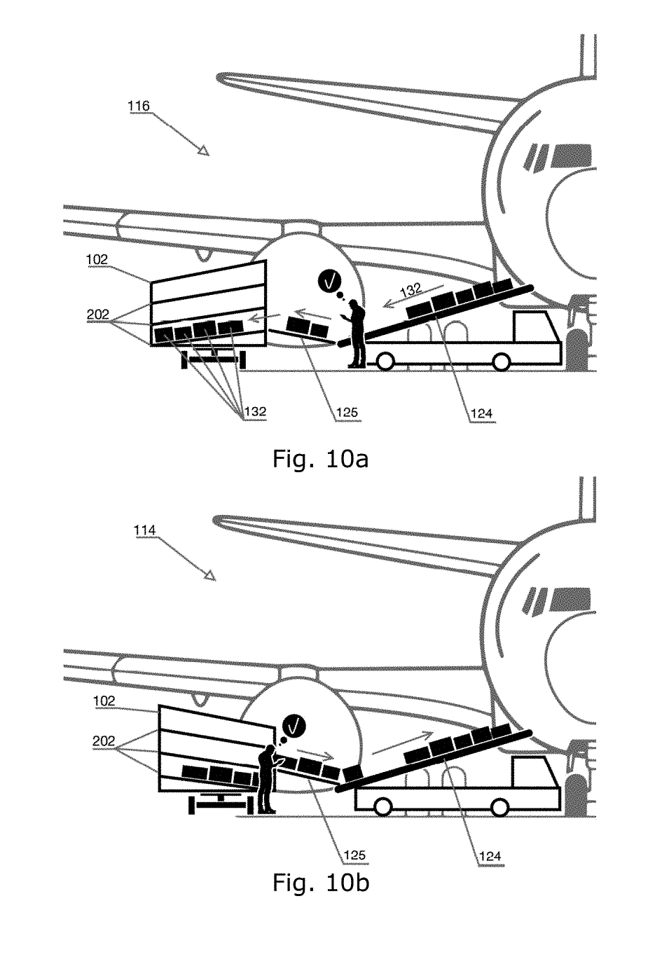

FIGS. 10a and 10b illustrate the handling of the items 132 at the aircraft departure site 116 (FIG. 10a) and at the aircraft arrival site 114 (FIG. 10b). As shown in FIG. 10a, items 132 are offloaded from an arriving aircraft by means of belt loader 124 and transferred to the cart shelves 202 of cart 102 by means of connecting conveyor 125.

The system hence also enables the transfer of items from the carts into the cargo hold of the aircraft in a nearly automated manner with no need for manual handling or lifting of items. Manual labour intervention may thus be limited to rotation of the storage section of the cart relative to the chassis, unless such rotation is motor driven, and possibly to handling of the connecting conveyor 125, such as successive alignment thereof with each one of the cart shelves. Such handling of the connecting conveyor may also be automated. The connecting conveyor 125 may form a branched structure with respective connecting conveyor branches extending to each one of the cart shelves.

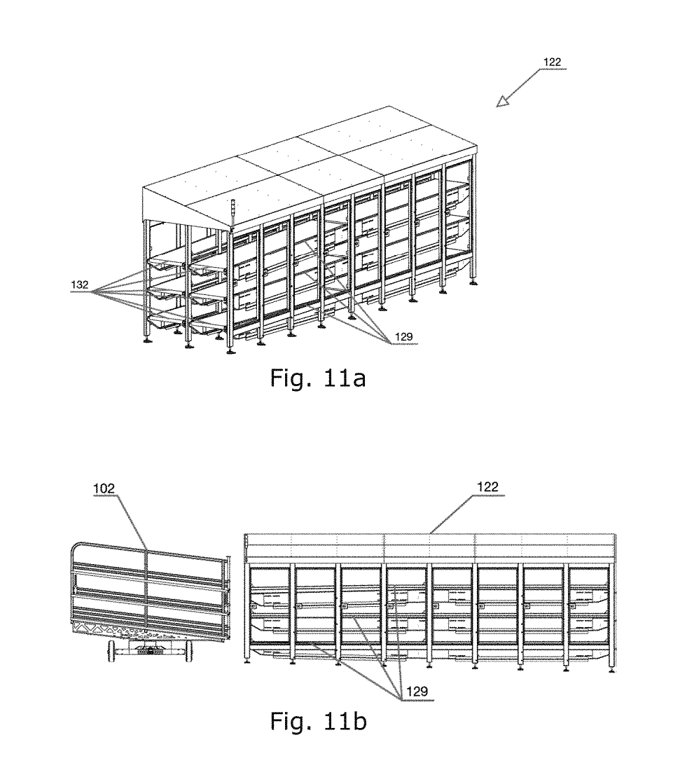

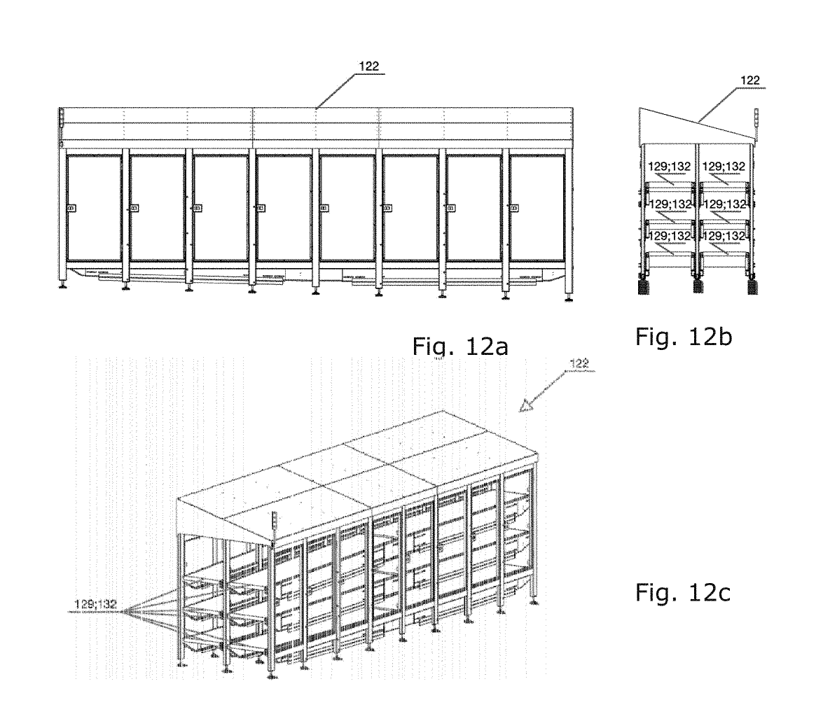

An embodiment of the arrival accumulation unit 122 is illustrated in FIGS. 11a, 11b, 12a-12c, and 13. The arrival accumulation unit 122 comprises a plurality of accumulation shelves 129 arranged in a matrix of rows and columns. Each shelf comprises a motor-driven conveyor belt 136, operation of which is preferably independently driveable and controllable by, e.g. an operator of the unit through an operator interface. The arrival accumulation unit 122 comprises an item loading end (to the left in FIGS. 11a, 11b and 12c) and an item off-loading end (to the right in FIGS. 11a, 11b and 12C). As illustrated in FIG. 11b, the loading end of the arrival accumulation unit 122 mates with the unloading end of the cart 102, with the number and layout of the shelves 202 of the cart 102 matching the number and layout of the shelves 129 of the arrival accumulation unit 122. The arrival accumulation unit 122 may thus receive items 132 offloaded by the cart 102. Hence, also as regards the transfer of items from the aircraft onto the delivery conveyor of an airport, all handling of the items is automated.

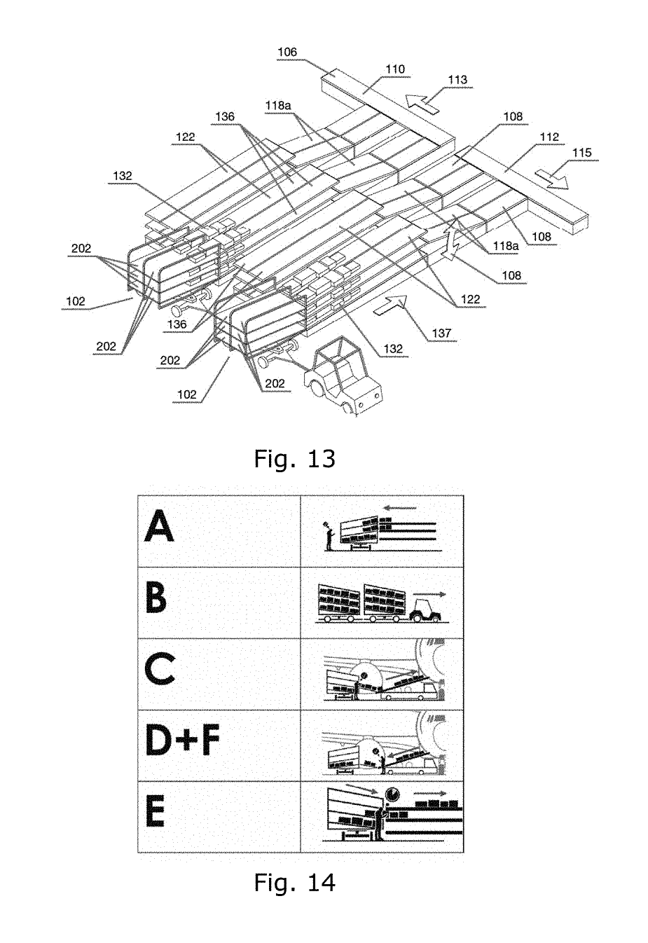

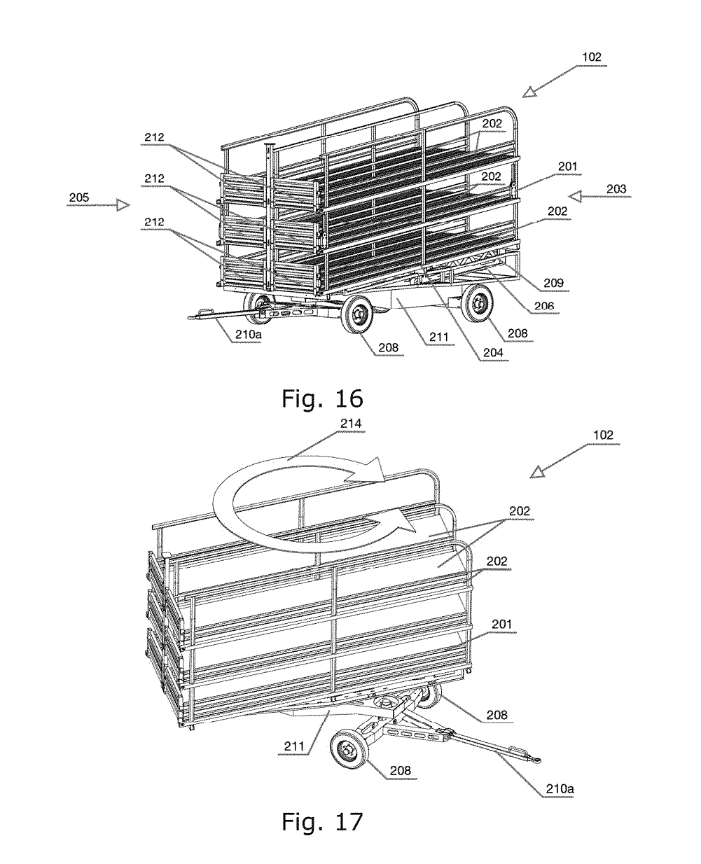

The arrival accumulation unit 122 is generally illustrated in FIG. 13. Arriving items 132 are offloaded from cart shelves 202 of carts 102 by discharge thereof onto belts 136 of arrival accumulation unit shelves 119. Within the arrival accumulation unit 122 the items 132 are buffered on belts 136, which convey the items in the direction of arrow 137. Delivery conveyor 108 comprises an inclinable conveyor section 108a configured to accept items 132 from selected pairs (one row at a time) of arrival accumulation unit shelves and belts 119, 136. In FIG. 13, the two lower right delivery conveyors 108 are connected to conveyor branch 112 for transferring arriving items 132 to a local luggage reclaim area, parcel distribution facility or the like (not shown) as indicated by arrow 115. The two upper left delivery conveyors 108 are arranged to transfer incoming transit items onto the sorting conveyor 106 for further sorting and subsequent re-departure thereof. The inclination of the cart shelves 202 provide an item transfer structure together with releasable closure structures 212 (see FIG. 16), by means of which the items 132 may be offloaded from the cart 102 by sliding of the cart shelves 202 under the action of gravity.

FIG. 14 illustrates five fundamental steps of operation of the system 100 as follows:

STEP A: transfer of departing items from the departure accumulation unit 118 onto the cart 102 at a sorting conveyor site.

STEP B: transfer of a train of carts from the sorting conveyor site 106 to the aircraft departure site.

STEP C: transfer of the departing items from each cart onto a belt loader and further into the cargo hold of an aircraft.

STEPS D AND F: transfer of arriving items from the aircraft cargo hold into the carts.

STEP E: transfer of the arriving items from the carts into the arrival accumulation unit.

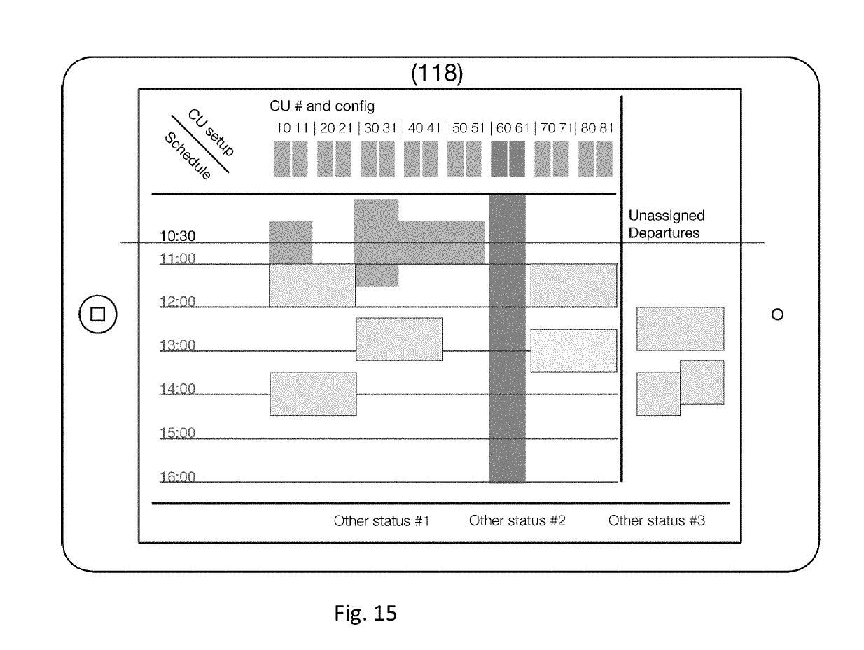

FIG. 15 illustrates a control scheme interface of the sorting conveyor 106 and departure accumulation units 118. A number of departure accumulation units numbered 10, 11, 20, 21, 30, 31, 40, 41, 50, 51, 60, 61, 70, 71, 80 and 81 are provided at respective unloading positions of the sorting conveyor 106. In the configuration shown, each of the departure accumulation units comprises two columns of shelves. As shown, departure accumulation units Nos. 10 and 11 are designated for a first flight until 11:00 o'clock. From 11:00 until 12:00 departure accumulation units Nos. 10, 11, 20 and 21 are designated for a second flight, and the same four units are designated for a third flight from 13:30 until 14:30. Likewise, departure accumulation units Nos. 30, 31, 40, 41, 50, 51, 70, 71, 80, and 81 are designated to various flights at various time slots. Departure accumulation units Nos. 60 and 61 are out of service for maintenance. As shown at the right-hand side of the interface, three flights have not yet been assigned to any departure accumulation units.

FIGS. 16-23 illustrate various embodiments of the cart 102 for use in the system 100. The cart 102 comprises a storage section 201 comprising a plurality of cart shelves 202, each of which is inclined relative to horizontal for automatically conveying items from an upper loading end 203 of the cart 102 towards a lower unloading end 205 thereof. The cart comprises a chassis 211 and a plurality of ground-engaging wheels 208, and a drawer 206 below the storage section 201. The drawer 206 comprises a compartment 207 (see FIG. 19) for accepting odd-size items when the drawer is in the open state as shown in FIG. 19. In the non-retracted, i.e. closed state of the drawer 206 shown in FIGS. 16-18, the compartment 207 is inaccessible, and the drawer is overlapped by a bottom portion 204 of the storage section 201. In the retracted, i.e. open configuration shown in FIG. 19, the compartment is accessible.

In use, the cart may be selectively operated with the drawer 206 in its open or in its closed state. Typically, ordinary items, such as suitcases and ordinary bags are loaded onto the shelves 202. If no odd-size or over-size items are to be transferred by the cart 102, it is normally operated with the drawer 206 in the closed state. For the transfer of odd-size or over-size items by means of the cart 102, it is operated with the drawer 206 in the open, i.e. retracted state as shown in FIG. 19 with the odd-size or over-size items resting in and extending upwardly from the compartment 207.

The drawer 206 has inclined side structures 209 which are configured to essentially correspond and extend in parallel to the inclined bottom surface 204 of the storage section 201.

A connecting element 210a is provided for coupling a first end of the cart 102 to a suitably configured connecting element 210b of the opposite end of an identical cart 102 to form a train of carts. As illustrated by arrow 214. At the unloading end 205, each of the shelves 202 is provided with a releasable and re-closable closing structure 212 for releasing the items supported by the respective shelves when the items are to be offloaded from the cart 102.

The storage section is preferably rotatable relative to the chassis 211 around an upright axis as shown by arc-shaped arrow 214 in FIG. 17 in order to orient the shelves and the transport direction of items within the cart relative to an external conveyor or accumulation means, such as an accumulation unit, belt loader or the like.

At least two carts 102 may be coupled or connected together to form a train of carts. A structure (not shown) for releasably locking the drawer in a selected one of a partly extracted position and a fully extracted position may be provided. For coupling the carts together to form a train of carts, the connecting element 210a, 210b may be provided, the free end of which is configured to connect the cart to another cart, the connecting element extending from the chassis 211 of the cart 102 below the drawer 206 in the direction of extraction of the drawer. The free end of the connecting element 210a, 210b is able to connect to another one of the carts when the drawer 206 is in the partly extracted position, whereas the free end of the connecting element 210a, 210b is unable to connect to the other one of the carts when the drawer 206 is in the fully extracted position. In operation, items may be selectively transported with the drawer in the fully or in the partly extracted position. When the drawer is in the partly extracted position, the first cart may be coupled to a second one of the carts by means of the connecting element with the drawer of the first cart facing the second cart. When the drawer is in the fully extracted position, items may be transported therein when the cart is not coupled to a further cart, or when the cart constitutes a first cart, which is coupled to a second cart by means of the connecting element with the drawer of the first cart facing away from the second cart. The length of the drawer, which may be as long as the cart or nearly as long as the cart may hence be fully utilized when the cart is the last one in a train of carts of is used as a stand-alone device, whereas the full length of the drawer does not occupy excessive space between neighbouring carts in a train of carts and hence does not unnecessarily limit the radius of curvature of the train.

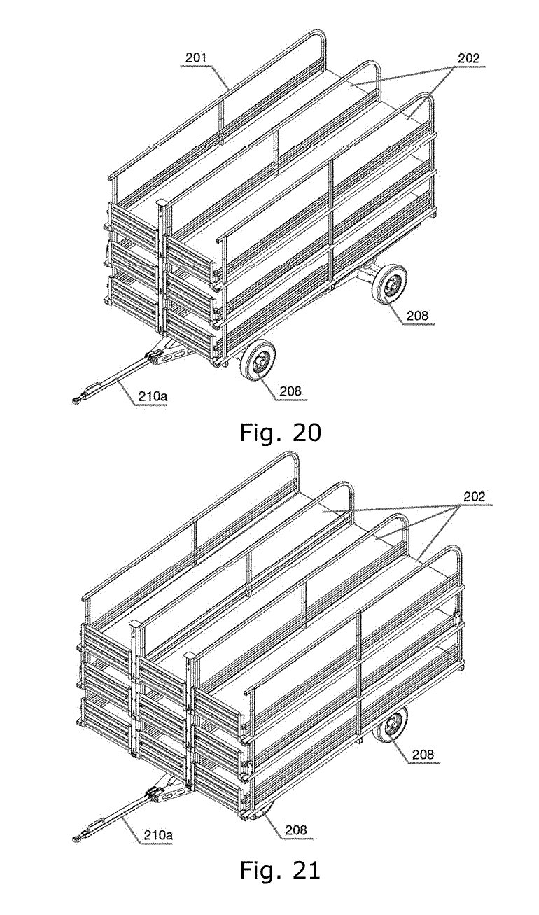

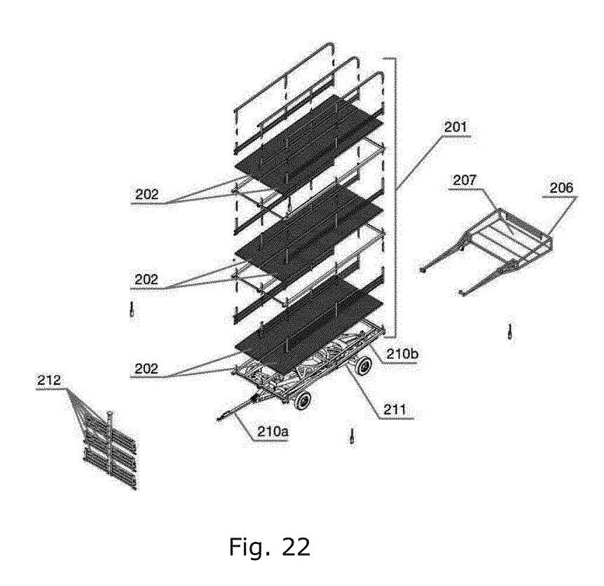

FIGS. 20 and 21 show two embodiments of the cart 102. In a first configuration shown in FIG. 20, the cart comprises two columns each comprising three rows of cart shelves 202, and in the embodiment of FIG. 21, the cart comprises three columns of cart shelves 202, each comprising three rows. In order to conveniently adapt the number of rows and columns to match any desired need, the cart may—as shown in FIG. 22—be assembled from a number of modules which may be configured and sized to match the need as given by a particular application.

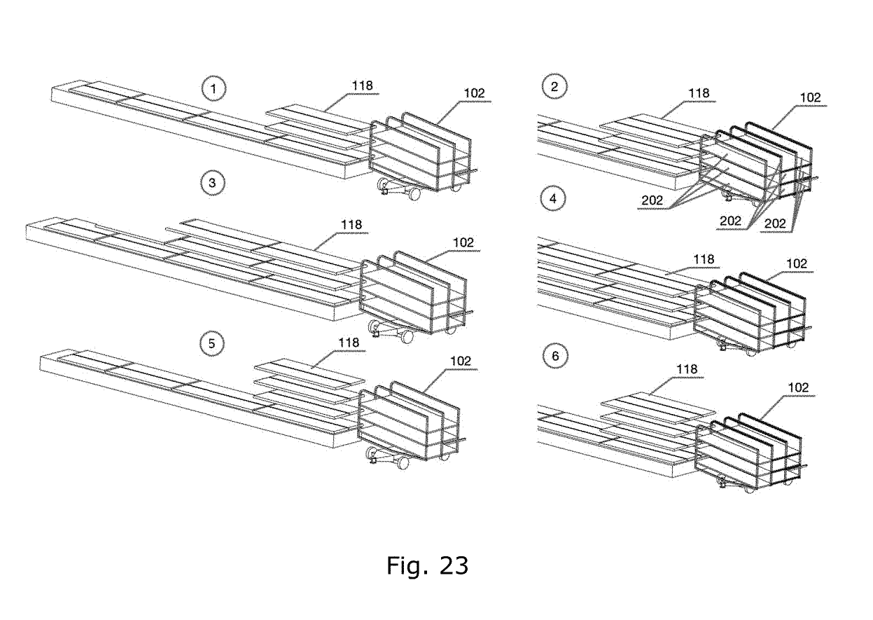

FIG. 23 shows various configurations of the cart 102 in a parking position in front of an accumulation unit 118 or other item storage or conveyor facility of loading of items onto the cart.

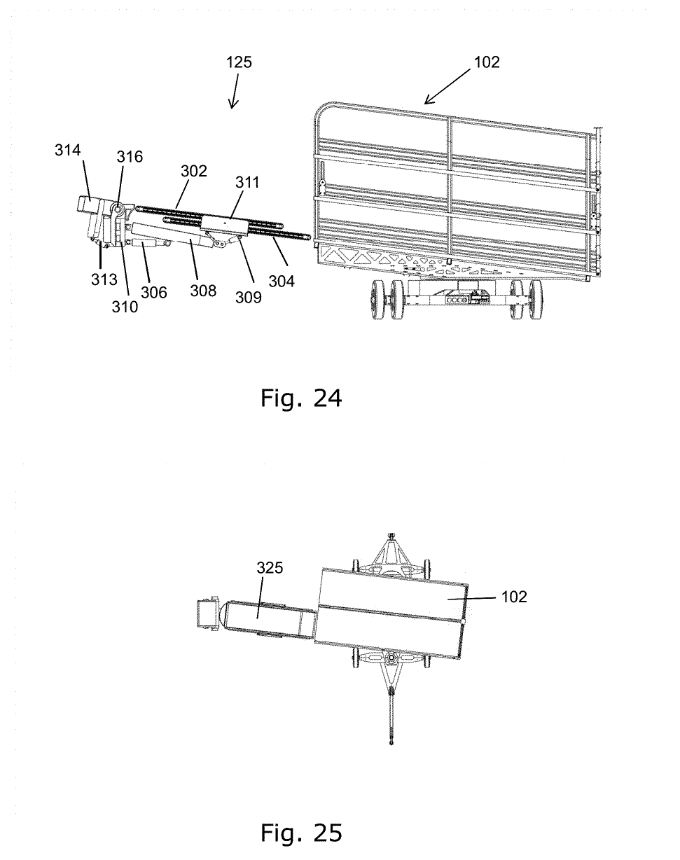

Embodiments of the connecting conveyor 125 are illustrated further in FIGS. 24-44. More specifically, FIGS. 24-34 show a first embodiment of the connecting conveyor 125 relying on partially overlapping belts, and FIGS. 35-44 show a second embodiment of the connecting conveyor 125 relying on a plurality of rollers mounted on a scissors extender.

The embodiment of the connecting conveyor 125 shown in FIGS. 24-34 comprises two mutually displaceable conveyor elements 302 and 304, including for example motor driven belts. Mutual displacement of the conveyor elements 302 and 304 is achieved by actuators 306 and 308, which may include linear actuators, such as hydraulically driven cylinders. In one embodiment, a first end of actuator 306 is privotally attached to a support arm 310, and a second end of actuator 308 is attached to actuator 308. A first end of actuator 308 is pivotally attached to the support arm 310, and a second end of actuator 308 attaches to the conveyor elements 203 and 304 via link and actuator structure 309 and mounting element 311. At pivotal point of attachment 316, the support arm 310 attaches to a carrier structure 314, the support arm 310 being further connected to the carrier structure 314 at a downward extension thereof via linear actuator 313, which may include a hydraulically driven cylinder. As shown in FIGS. 24-34, activation of the actuators and links 306, 308, 309 and 313 may cause the conveyor elements 302 and 304 to mutually displace in a linear direction in order to extract one of them relative to the other. Further, activation of the actuators and links 306, 308, 309 and 313 may cause the conveyor elements 302 and 304 to pivot relative to the carrier structure 314 around pivotal point of attachment 316. In FIGS. 24-26 and 28, the conveyor elements 302 are in a configuration for loading items onto the cart 102 by movement of the items from the left to the right in the drawings. For unloading of items from the cart 102 onto the connecting conveyor 125, i.e. for movement of items from the right to the left in the drawings, the conveyor elements 302 and 304 are brought into the configuration shown in FIGS. 29, and 32-34. In FIGS. 27, 30 and 31, the conveyor elements are in a parked position.

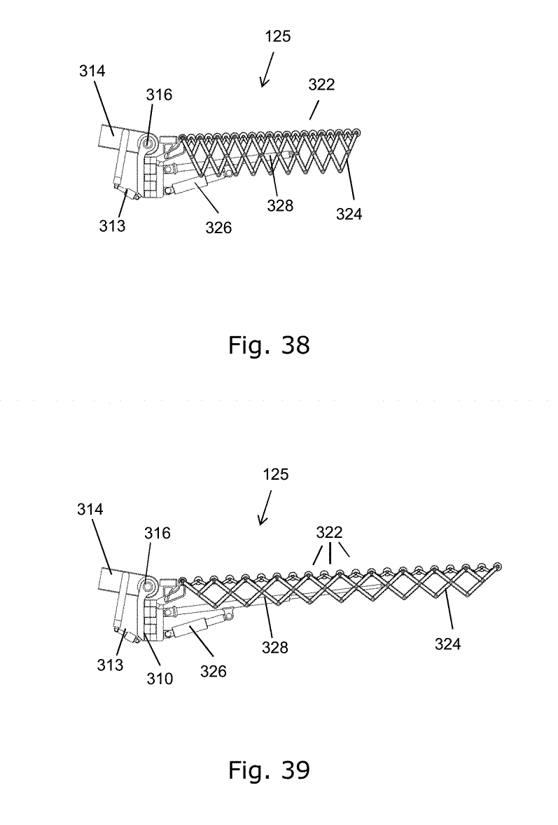

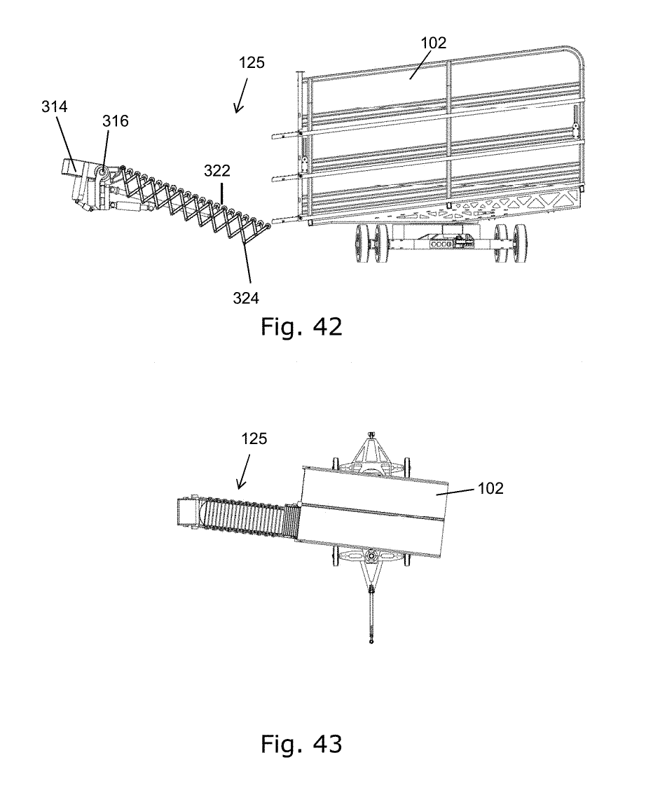

In an alternative embodiment of the connecting conveyor 125 shown in FIGS. 35-44, a plurality of rolling elements 322, which may be motor-driven or freely rotatable, are mounted on a scissors extender 324, which is pivotally supported at 316 relative to carrier structure 314 and extractable by activation of linear actuators 326 and 328 mounted on arm 310 and connected to the carrier structure 314 via actuator 313. Activation of the actuators 326, 328 and 313 may cause the scissors extender to extend or retract as desired and to pivot around point of attachment 316. FIGS. 35-37 show a loading configuration for conveying items onto the cart 102 from left to right in the drawings, and FIGS. 42-44 show an unloading configuration for conveying items away from the cart from right to left in the drawings. Various configurations for loading, unloading and parking are shown in FIGS. 38-41.

Further variations of the connecting conveyor are disclosed in FIGS. 24-44.

1.-17. (canceled)

18. A system for handling of luggage or parcel items, comprising:
at least one principal conveyor for conveying the items to respective unloading positions along the principal conveyor;
a first item buffer section comprising a number of first item accumulation units arranged at the unloading positions of the principal conveyor,
wherein each of the first item accumulation units comprises a plurality of shelves for storing a plurality of items on each shelf, each shelf extending in a longitudinal direction from an inlet end of the first item accumulation unit to an outlet end thereof; and
wherein at least one directing apparatus at each unloading position for directing the items onto the shelves of the first item accumulation units;
a second item buffer section comprising a number of second item accumulation units, wherein each of the second item accumulation units comprises a plurality of shelves for storing a plurality of items on each shelf, each shelf extending in the longitudinal direction from an inlet end of the second item accumulation unit to an outlet end thereof;
an item transfer apparatus for receiving items unloaded from the first item accumulation units at their unloading ends, and for loading the items unloaded from the first item accumulation units onto the second item accumulation units at their loading ends;
a control system for controlling operation of the item transfer apparatus, so as to distribute the items unloaded from the first item accumulation units among the second item accumulation units.

19. The system according to claim 18, further comprising at least one further item accumulation unit arranged successively in said longitudinal direction, and a further item transfer apparatus between each one of the second and further item accumulation units.

20. The system according to claim 18, wherein each item transfer apparatus is transversably movable in a space between successive items accumulation units.

21. The system according to claim 20, further comprising a plurality of dispatch stations downstream of the outlet of a last one of the item accumulation units, wherein the or each item transfer apparatus is controlled to sort the items, so as to direct each item to an individually selected one of the dispatch stations.

22. The system according to claim 18, wherein the item accumulation units are arranged in rows,
wherein each row comprises a plurality of item accumulation units;
the item transfer apparatus is/are arranged in spaces between the rows of item accumulation units.

23. The system according to claim 22, wherein the number of item accumulation units in an upstream row is higher than the number of item accumulation units in a downstream row.

24. The system according to claim 18, wherein the item transfer apparatus or at least one of the plurality of item transfer apparatus is operable to selectively convey the items forwardly in a direction towards the dispatch stations or backwardly in a direction away from the dispatch stations.

25. The system according to claim 18, wherein the at least one directing apparatus comprises an elevateable conveyor operable to selectively feed each of the items unloaded from the principal conveyor onto a selected shelf of the first item accumulation unit.

26. The system according to claim 20, further comprising at least one item buffer unit in the space between successive ones of the item accumulation units, each item buffer unit comprising a plurality of shelves for storing a plurality of items on each shelf.

27. The system according to claim 26, wherein each of the at least one item buffer unit is transversely movable in said space.

28. The system according to claim 18, wherein each of the item accumulation units, the item transfer apparatus, and the buffer units include a plurality of identical building block elements.

29. The system according to claim 18, wherein each of the shelves of the item accumulation units and/or each of the shelves of the item buffer units is configured to convey the items stored on each shelf from a loading end to an unloading end of the shelf.

30. The system according to claim 18, further comprising an odd-size item unloading position at the principal conveyor for receiving odd-size items.

31. The system according to claim 18, further comprising compliance determination means for determining each item's geometrical compliance and/or its orientation compliance with the item accumulation units, and deflection means for deflecting non-compliant items away from the first item accumulation units, so as to prevent the non-compliant items from being loaded into the item accumulation units, the deflection means being arranged between the unloading position at the principal conveyor and the first item accumulation unit.

32. The system according to claim 18, wherein the item accumulation units at the dispatch stations form a row of dispatch units, the system further comprising a plurality of wheeled carts, each cart comprising a chassis and a storage section comprising a plurality of cart shelves for accepting items unloaded from the dispatch units, and wherein the storage section of each cart is rotatable relative to the cart's chassis around an upright axis.

33. The system according to claim 21, wherein the at least one item transfer apparatus is controllable to combine items from at least two of the unloading positions at the principal conveyor into any one of the dispatch stations.

34. A system for handling of luggage or parcel items, comprising:
at least one cart comprising a plurality of cart shelves, each of which is sized to accommodate a plurality of said items;
at least one item conveyor selected among:
a sorting conveyor for conveying the items from a sorting conveyor loading position to respective unloading positions along the sorting conveyor; and
a delivery conveyor for conveying the items from a delivery conveyor loading position to a luggage reclaim area, or to the sorting conveyor, or to a parcel distribution facility, or to a further conveyor.
